(19) United States
(12) Patent Application Publication
(10) Pub. No.: US 2016/0055490 A1
(43) Pub. Date: Feb. 25, 2016

(54) DEVICE, SYSTEM, AND METHOD OF PROTECTING BRAND NAMES AND DOMAIN NAMES

(71) Applicant: BRANDSHIELD LTD., Ramat-HaSharon (IL)

(72) Inventors: Yoav Keren, Ramat Hasharon (IL); Yuval Zantkeren, Ramah Hasharon (IL); David Fridman, Hod Hasharon (IL)

(21) Appl. No.: 14/782,791

(22) PCT Filed: Apr. 9, 2014
(86) PCT No.: PCT/IB2014/060577

§ 371 Date: Oct. 7, 2015

Related U.S. Application Data
(60) Provisional application No. 61/810,742, filed on Apr. 11, 2013.

(51) Int. Cl. G06Q 30/00; H04L 29/12; G06Q 30/02; G06F 17/30

(52) U.S. Cl. CPC G06Q 30/0185; G06F 17/30864; G06F 17/3053; H04L 61/1511; G06F 17/30873; G06F 17/30876; G06Q 30/0248

(57) ABSTRACT

A computerized method of protecting a brand name of a brand owner, includes: (a) crawling a global communication network to identify and collect data about web-sites that possibly abuse the brand name; (b) for each web-site that possibly abuses the brand name, analyzing whether or not the web-site abuses the brand name by analyzing at least one of: (i) content of the web-site; and (ii) data about an owner of the web-site. The method further includes: for each web-site that possibly abuses the brand name, (A) generating an investment score indicating an estimated level of investment that was invested in development of the web-site; and (B) generating a damage score indicating a level of damage that the web-site is estimated to produce to the brand name.

### CROSS-REFERENCE TO RELATED APPLICATIONS

This application claims priority and benefit from U.S. provisional patent application No. 61/810,742 filed on Apr. 11, 2013, which is hereby incorporated by reference in its entirety.

### FIELD OF THE INVENTION

The present invention relates to the field of brand names and domain names.

### BACKGROUND

Millions of users utilize the Internet every day, in order to read or otherwise consume web content. For example, a user may utilize a personal computer, a laptop computer, a smartphone or a tablet, typically running a browser, in order to read online news, watch online videos, interact with other users through social networks, play online games, or the like.

Many companies and business entities invest large amounts of money in order to produce and maintain high-quality websites. Such websites may allow users to find information about products and services, to read news about products and services, to perform online purchases of products and services, or the like.

### SUMMARY

The present invention may comprise, for example, devices, systems, and methods for protecting brand names and domain names.

The present invention may include a computerized or automated method of protecting a brand name of a brand owner. The method may comprise: (a) crawling a global communication network to identify and collect data about web-sites that possibly abuse the brand name; (b) for each web-site that possibly abuses the brand name, analyzing whether or not the web-site abuses the brand name by analyzing at least one of: (i) content of said web-site; and (ii) data about an owner of said web-site.

The method may comprise: for each web-site that possibly abuses the brand name, generating an investment score indicating an estimated level of investment that was invested in development of said website.

The method may comprise: for each web-site that possibly abuses the brand name, generating a damage score indicating a level of damage that said web-site is estimated to produce to said brand name.

The method may comprise: for each domain that possibly abuses the web-site, generating a popularity score indicating a level of popularity of said web-site among users of the global communication network.

The method may comprise: for each domain that possibly abuses the brand name, generating a relevance score indicating a level of relevance of said domain to said brand.

The method may comprise: for each web-site that possibly abuses the brand name, generating an aggregated risk score based on, at least, one or more of: said investment score, said popularity score, said damage score, and said relevance score.

The method may comprise: identifying a common pattern among multiple web-sites that are determined, by the computerized method, to be abusing the brand name.

In some embodiments, identifying the common pattern among the multiple web-sites is performed based on at least one of: identifying common domain ownership for said multiple web-sites; identifying common domain registrar for said multiple web-sites; identifying common DNS server for said multiple web-sites; identifying common Internet Protocol (IP) address for said multiple web-sites; identifying common content for said multiple web-sites; identifying common website use type for said multiple domains; identifying that multiple Internet Protocol (IP) addresses of said multiple web-sites belong to a same country; identifying that said multiple web-sites have a same country code Top-Level Domain (ccTLD); identifying that WHOIS records of said multiple web-sites share at least one same contact detail.

The method may comprise: identifying a batch of multiple web-sites, that are owned by different entities and are determined by the computerized method to be abusing the brand name; automatically generating drafts of cease-and-desist notifications directed to said entities; upon approval of the brand owner, sending out said cease-and-desist notifications to said entities.

The method may comprise: for a particular web-site that is determined by the computerized method to be abusing the brand name: automatically analyzing at least (i) content of said web-site, and (ii) domain registration data of said web-site: based on said analyzing, automatically presenting to the brand owner at least one option selected from: (a) to automatically send a cease-and-desist notification to an owner of said particular web-site, (b) to automatically start a negotiation process for purchasing said particular web-site, (c) to automatically send a take-down notice to a hosting service of said web-site.

The method may comprise: generating a list of multiple web-sites that are determined by the computerized method to be abusing said brand name; presenting to the brand owner said list of multiple web-sites.

The method may comprise: sub-grouping web-sites in said list, based on Top-Level Domain (TLD) of said web-sites.

The method may comprise: sub-grouping web-sites in said list, based on country code Top-Level Domain (ccTLD) of said web-sites.

The method may comprise: sub-grouping domains in said list, based on a level of aggregated risk to the brand name.

The method may comprise: based on keywords entered by the brand owner, analyzing crawled data and identifying web-sites that abuse the brand name; wherein the keywords entered by the brand owner are used for generating a relevance score for each one of said web-sites.

The method may comprise: based on names of one or more competitors, that are entered by the brand owner, analyzing crawled data and identifying web-sites that abuse the brand name.

The method may comprise: based on a use type of a possibly-abusing web-site, analyzing crawled data and determining whether or not the possibly-abusing web-site abuses the brand name.

The method may comprise: determining that a possibly-abusing web-site is used for domain parking; based on said determining, generating a determination whether or not the possibly-abusing domain abuses the brand name.

The method may comprise: determining that a possibly-abusing web-site is used for pay-per-click advertisements; based on said determining, generating a determination that the possibly-abusing web-site abuses the brand name.

The method may comprise: determining that a possibly-abusing web-site is used for redirecting Internet traffic to a website associated with a competitor of the brand owner; based on said determining, generating a determination that the possibly-abusing web-site abuses the brand name.

The method may comprise: determining that a possibly-abusing web-site is used for electronic commerce of counterfeit merchandise; based on said determining, generating a determination that the possibly-abusing web-site abuses the brand name.

The method may comprise: generating a determination that a possibly-abusing web-site abuses the brand name, based on an analysis that takes into account at least one of: (i) a current content of said possibly-abusing web-site; (ii) a past content of said possibly-abusing web-site, which is different from said current content.

The method may comprise: generating a determination that a possibly-abusing web-site abuses the brand name, based on an analysis that takes into account at least one of: (i) a current type of use of said possibly-abusing web-site; (ii) a past type of use of said possibly-abusing web-site, which is different from said current type of use.

The method may comprise: determining that a possibly-abusing web-site appears in a pre-defined white-list of web-sites that are authorized by the brand owner to mention the brand name; based on said determining, generating a determination that the possibly-abusing web-site does not abuse the brand name.

The method may comprise: determining that a possibly-abusing web-site is owned by an authorized affiliate of the brand owner; based on said determining, and based on other estimated risk factors associated with said web-site, generating a determination whether or not the possibly-abusing web-site is abusing the brand name.

The method may comprise: determining that a possibly-abusing web-site is owned by an authorized affiliate of the brand owner, based on a unique code portion that is found embedded within a source code served from said web-site, wherein the unique code portion is unique per authorized affiliate of the brand owner.

The method may comprise: determining that a possibly-abusing web-site is owned by an authorized affiliate of the brand owner, based on a unique code portion that is found embedded within a source code served from said web-site, wherein the unique code portion is unique per website of authorized affiliate of the brand owner.

The method may comprise: determining that a web-site that abuses the brand name, performs at least one of: (a) sells counterfeit merchandise; (b) directs users to a website of a competitor of the brand owner; in response to said determining, increasing the damage score for said web-site.

The method may comprise: analyzing at least one of: (i) content of a list of domains that are owned by the brand owner, (ii) Internet traffic to said list of domains that are owned by the brand owner; based on the analyzing, identifying a particular domain on said list, that is under-monetized; generating a notification to the brand owner to perform self-monetization of said particular domain.

The method may comprise: collecting domain registration data for a batch of domains that are owned by the brand owner; analyzing the domain registration data for said batch of domains, to determine at least one domain having registration details that are incorrect; generating a notification to the brand owner, indicating that said at least one domain has registration details that require correction.

The method may comprise: automatically correcting domain registration data, for the at least one domain that has incorrect domain registration details, based on a default profile of registration data pre-defined by said brand owner.

The method may comprise: collecting domain registration data for a batch of domains that are owned by the brand owner; analyzing the domain registration data for said batch of domains, to determine upcoming expiration dates of said domains; based on the analyzing, generating notifications to the brand owner with regard to domain renewals, grouped into (i) a first group of urgent domain renewals, and (ii) a second group of non-urgent domain renewals.

The method may comprise: performing a domain availability analysis that takes into account at least one of: (i) the brand name; (ii) one or more user-provided keywords that are related to the brand name; (iii) one or more system-generated keywords that are related to the brand name; (iv) one or more countries-of-interest; (v) one or more global Top-Level Domains (gTLDs) of interest; based on the domain availability analysis, performing a domain opportunity analysis to determine a particular domain name that is (A) available for registration, and (B) is relevant to the brand name; generating a notification that proposes to the brand owner to register said particular domain.

The method may comprise: based on the domain opportunity analysis, performing generating a list of multiple domains that are (a) available for registration, and (b) are relevant to the brand name; ranking said list of multiple domains by using a prioritizing algorithm that takes into account at least one of: (A) system-generated keywords; (B) user-provided keywords; (C) countries-of-interest; (D) global TLD of interest; (E) semantic analysis of the brand name; (F) common typos; (G) common linguistic mutations.

The method may comprise: generating a mutation of said brand name by introducing a typographical error to said brand name; generating a candidate domain by adding a Top Level Domain (TLD) suffix to the mutation of the brand name; based on domain registrar data, checking whether the candidate domain is registered to an entity other than the brand owner; if the candidate domain is registered to an entity other than the brand owner, then, (i) analyzing a use of a website served from said candidate domain, and (ii) based on the analyzing, determining whether the candidate domain is abusing the brand name.

The method may comprise: generating a mutation of one or more keywords that are related to said brand name, by introducing a typographical error to said one or more keywords; generating a candidate domain by adding a Top Level Domain (TLD) suffix to the mutation, wherein the candidate domain comprises said brand name and said mutation of one or more keywords; based on domain registrar data, checking whether the candidate domain is registered to an entity other than the brand owner; if the candidate domain is registered to an entity other than the brand owner, then, (i) analyzing a use of a website served from said candidate domain, and (ii) based on the analyzing, determining whether the candidate domain is abusing the brand name.

The method may comprise: determining one or more keywords, that are related to the brand name; performing a search engine query that comprises said one or more keywords; selecting a web-site that appears in search results of said search engine query; analyzing at least one of: (i) content of said web-site, (ii) Internet traffic to said web-site, to determine whether or not said website abuses the brand name.

The method may comprise: determining one or more keywords, that are related to the brand name; performing a search engine query that comprises said one or more keywords; selecting a web-site that appears in search results of said search engine query; obtaining through a domain registry data about an owner of said web-site; if said web-site is owned by an entity other than the brand owner, then, analyzing content of said web-site to determine whether or not said web-site abuses the brand name.

The method may comprise: generating a cost effectiveness score for Search Engine Optimization (SEO) operations performed for a website of the brand owner, by: (a) at a first time point, determining a first ranking of said website in search results of a particular search engine; (b) at a second time point, determining a second ranking of said website in search results of a particular search engine; (c) obtaining a user indication of monetary investment in SEO performed between the first time point and the second time point; (d) generating the cost effectiveness score by taking into account, at least, the change between the first ranking and the second ranking, and said monetary investment in SEO.

The method may comprise: generating a cost effectiveness score for digital marketing operations performed for a website of the brand owner, by: (a) at a first time point, determining a first ranking of said website in search results of a particular search engine; (b) at a second time point, determining a second ranking of said website in search results of a particular search engine; (c) obtaining a user indication of monetary investment in digital marketing performed between the first time point and the second time point; (d) generating the cost effectiveness score by taking into account, at least, a change between the first ranking and the second ranking, and said monetary investment in digital marketing.

The method may comprise: generating a cost effectiveness score for Search Engine Optimization (SEO) operations performed for a website of the brand owner, by: (a) at a first time point, determining a first ranking of said website in search results of a particular search engine; (b) at a second time point, determining a second ranking of said website in search results of a particular search engine; (c) generating the cost effectiveness score by taking into account, at least, change between (i) the first ranking at the first time-point, and (ii) the second ranking at the second time point.

The method may comprise: generating a cost effectiveness score for digital marketing operations performed for a website of the brand owner, by: (a) at a first time point, determining a first ranking of said website in search results of a particular search engine; (b) at a second time point, determining a second ranking of said website in search results of a particular search engine; (c) generating the cost effectiveness score by taking into account, at least, change between (i) the first ranking at the first time-point, and (ii) the second ranking at the second time point.

In some embodiments, the brand name comprises (or is) a name of a person.

In some embodiments, the analyzing further takes into account at least one of: keywords used in the content of said web-site, Internet traffic data for said web-site. Search Engine Optimization (SEO) data of said web-site, structure of said web-site, programming technologies used by said web-site.

In some embodiments, generating the investment score is based on an analysis that takes into account at least one of: level of sophistication of one or more programming technologies used by said web-site; whether one or more programming technologies used by said web-site are recent or outdated; an amount of content contained in said web-site; a number of web-pages contained in said web-site; whether or not said web-site is compliant with World Wide Web Consortium (W3C) requirements; whether or not said web-site is compliant with Search Engine Optimization (SEO) standards.

The method may comprise: identifying a common pattern for multiple cross-brand abusing websites.

The method may comprise: detecting a first website which abuses a first brand name of a first brand owner; detecting a second website which abuses a second, different, brand name, of a second, different, owner; detecting one or more common characteristics that are common the first and second websites.

The method may comprise: sending a notification about detection of the multiple cross-brand abusing websites, to at least one of the first brand owner and the second brand owner.

The method may comprise: sending a notification about detection of the multiple cross-brand abusing websites, to at least one of the first brand owner and the second brand owner; enabling a cooperative action to be taken by the first and second brand owner.

The method may comprise: determining that a certain website is abusing the brand name; searching in a secondary marketplace for domains and/or websites, whether said certain website is offered for sale; if said certain website is offered for sale, through said secondary marketplace, then enabling to the brand owner to purchase said certain website through an automated system that interfaces with said secondary marketplace.

The method may comprise: determining that a batch of multiple websites are abusing the brand name; searching in a secondary marketplace for domains and/or websites, which ones of said multiple websites are offered for sale; generating a list of said multiple websites that are abusing the brand name, and indicating on said list one or more of the websites that are offered for sale on the secondary marketplace.

The method may comprise: scanning an entire registry of a Top-Level Domain (TLD) for websites that abuse any one of a group of brand names; generating a risk score for each one of said websites; based on the risk score, generating a ranked list of said websites.

The method may comprise: scanning an entire registry of a Top-Level Domain (TLD) for websites that are non-compliant with one or more rules that apply to said TLD registry; generating a non-compliance score for each one of said websites; based on the non-compliance score, generating a ranked list of said websites.

The method may comprise: determining that a certain website is possibly abusing the brand name; capturing and storing a screenshot of said website, together with a time-and-date stamp.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments of the present invention;

FIG. 2 is a schematic block diagram illustration of a system, in accordance with some other demonstrative embodiments of the present invention;

FIG. 3 is a schematic illustration of a user interface and screen, generated and displayed by the Evaluation Module, in accordance with some demonstrative embodiments of the present invention;

FIG. 4 is a schematic illustration of an on-screen dashboard, which may be generated and displayed in accordance with some demonstrative embodiments of the present invention;

FIG. 5 is a schematic illustration of a Brand Risks interface, which may be generated and displayed in accordance with some demonstrative embodiments of the present invention;

FIG. 6 is a schematic illustration of Brand Opportunities interface, which may be generated and displayed in accordance with some demonstrative embodiments of the present invention;

FIG. 7 is a schematic illustration of Management Module interface, which may be generated and displayed in accordance with some demonstrative embodiments of the present invention;

FIG. 8 is a schematic illustration of Management Module sub-section interface, which may be generated and displayed in accordance with some demonstrative embodiments of the present invention;

FIG. 9 is a schematic block diagram illustration of another system, in accordance with some demonstrative embodiments of the present invention; and

FIG. 10 is a schematic block diagram illustration of another system, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

Applicants have realized that scanning the Internet reveals a growing problem for organizations active online—from small companies to large enterprises—most of them suffer from dozens to hundreds (or even thousands) of websites that infringe their trademark and abuse their brand, or sell counterfeits of the brand owner's products, or otherwise imitate the “original” or legitimate website, or otherwise defraud users to think that an imitation website is “affiliated with” the legitimate or original website or brand owner.

For example, a major income source on the Internet is to lure visitors to websites that pay for each “click” on Pay-Per-Click ads or listings and other similar methods. As a result, unethical parties are motivated to use illegitimate or illegal activities in order to attract more visitors. One of the main avenues for these attacks is by utilizing domain names, usually domain names that may be confused with brand names or with trademarks or service marks, because of vulnerabilities in the domain name and DNS system.

Some brand abuse websites do not necessarily use domain name that include the brand name, but rather, they may abuse the brand or infringe the trademark in their content and/or their activity (such as redirecting to competitors, or selling counterfeit products, etc.)

Furthermore, the Internet provides numerous opportunities and means to all who wish to harm companies or organizations such as hackers, former employees, disgruntled employees, competitors, cyber-squatters and also criminals and/or terrorist organizations. All of the above may be motivated by a desire to damage the organization, gain economical profit or accomplish other monetary or ideological goals. Applicants have realized that in most cases there is a direct economic damage and brand equity damage to the company who legally owns the brand.

Applicants have realized that the risks that organizations face may include, for example: (a) Websites or webpages that abuse the brand and/or infringe the trademark; (b) The usage of a company's brand to attract users to other websites, sometimes to competitors websites, and by that “stealing” user traffic from the legitimate brand websites; (c) Websites that sell counterfeit products or fake products, and websites used for “grey” market sales (unauthorized sales of products); (d) Websites that abuse the brand and sell competing products or services; (e) Trademark infringement and brand abuse through phonetic imitation and typos (typographical errors) of domain names (many times used for “parked domains” websites that contain Pay Per Click (PPC) advertisements or other types of online advertisements and are intended to exploit the brand by attracting user traffic); (f) Fraudulent websites used for counterfeiting and corporate impersonation (including but not limited to Phishing and Pharming websites, spoofed blogs, etc.); (g) Slander and distribution of offensive information or damaging information or dis-information or negative information over the Internet. These brand protection problems that organizations face are accompanied by domain name portfolio management problems and other digital brand management problems.

There are hundreds of Top Level Domain extensions (TLDs). Some have second Level Domains (SLDs) that are used as extensions (for example “.co.uk”, “.kids.us”, etc.). Overall there are today hundreds of TLDs and SLDs active on the Internet worldwide. Soon, hundreds of new generic TLDs (gTLDs) will be added to the Internet root zone as part of an initiative of the Internet Corporation for Assigned Names and Numbers (ICANN). Many of these TLDs will be Internationalized TLDs (IDNs), which are TLDs in language scripts different than Latin (for example Chinese, Japanese, Hebrew, Arabic, etc.).

Every TLD is managed by a different registry and is registered in a different database. Many of the registries use different technologies, different registration protocols, different procedures and/or different registration rules and restrictions.

Companies and organizations around the world have digital assets which are a combination of accumulated brands, trademarks, mergers and acquisitions of companies, international branches, IT systems, web-based systems and more. Some of the basic parts of those digital assets are the domain names owned by those organizations. Medium size and large organizations may have dozens, hundreds, thousands and even tens of thousands of domain names. The value of these domain names can reach millions of dollars, and loss of revenues due to a malfunction or an attack on the activity of these domain names can also reach millions of dollars.

Applicants have realized that domain portfolio and brand management problems include, for example: (a) control and monitoring problem; (b) evaluation problem; (c) technical procedures; (d) damage as a result of malfunctions; (e) structural absence of organizational control; (f) security problems; (g) organizational responsibility problem; (h) absence of ERP integration; (i) loss of revenue and/or profit, due to loss of Internet traffic, counterfeit sales, fraud, and/or brand dilution.

Control and monitoring problem—small size, medium size and large companies spend from thousands of dollars to millions of dollars for the registration and the maintenance of their domain names portfolio. These assets must be managed. The existing management capabilities are limited. Domain names affect critical processes and therefore there is a need for adequate tools to manage them. Furthermore, there are no adequate monitoring solutions that help assessing whether these domain portfolio expenses are effective.

Evaluation problem: it is important for organizations to know or to estimate the value of the domain names that they own, and the relative contribution of the websites active on those domain names to their brand(s). Currently there are no adequate tools that provide effective and reliable solutions to evaluate these digital assets and their contribution. There are no systems that can analyze these assets and their value, and there are no tools that define measures for these evaluations.

Numerous technical procedures: organizations are forced to manage their digital assets and domain names in a non-effective method due to the fact that they are required to have relationships with hundreds (and soon thousands) of registries and registrars. As explained above, each registry may have different procedures and rules and protocols, a fact that creates a significant administrative problem and overhead for organizations.

Damages as a result of malfunctions: the absence of adequate and effective control and monitoring tools may result in a non-renewal of domain names because of oversight or technical errors, causing website failures, shutdown of mail servers, and/or the loss of domain names. Such errors may create significant financial damages to organizations, and in some cases the losses may be irreparable.

Structural absence of organizational control: the management of domain names is done through registrars and registries, which are parties external to the organization that owns the domain names, and not through one of the organization's departments. This creates a structural weakness since the registrars and registries will always be outside of the organization's control. This is a technical weakness as well as a security weakness.

Security problems: the security risks for domain names are in constant growth. These risks include domain name hijacking through fraud or modification in the registries or registrars, website closure through unauthorized modifications of domain settings, “pharming” attacks used for frauds, impersonation performed through gaining control over a domain name, industrial espionage, malware distribution, and more. These security problems are many times a result of the lack of control of the domain names portfolio. These problems can result in significant damages, direct losses, potential revenue losses, and malfunctions of critical systems of the organization.

Organizational responsibility problem: there are at least three different departments in the organization that may be involved with different aspects of the digital brand management (including brand protection and domain name portfolio management): The Information Technologies (IT) department which is usually responsible of the technical aspects of the domain registrations and the websites operation, the marketing department which is responsible for the branding aspects and the brand equity, and the legal department which is responsible for protecting the organization's trademarks and brands. Often, other executives in the organization may be involved, for example, C-level executives, finance or accounting department, or the like. The fact that there is more than one party in the organization responsible for brand management may create lack of control, inefficiency, redundancy, overlaps, contradicting decisions, and possible malfunctions. Moreover brand management usually lacks a metrics based strategy.

Absence of ERP integration: there are no domain management and/or brand protection tools which may be integrated with the existing organizational management systems, such as ERP systems, and therefore the coordination between the different departments is deficient and/or partial.

The present invention comprises devices, systems, and methods which may be used in order to solve, reduce, prevent, eliminate and/or mitigate some or all of the problems that the Applicants have realized to exist.

The term “Protected Brand” as used herein may include, for example, a brand name and/or a domain name and/or a website name and/or a trade-mark and/or a service-mark, which is owned by a legal owner, who seeks to protect and/or defend such brand from third-parties who may attempt to damage and/or abused such brand, directly or indirectly. The term “Protected Brand” may include, for example, a name of a company (e.g., “Samsung”), a name of a product (e.g., “Galaxy Note”), a name of a service, a slogan, a name of a person (e.g., a famous person, a “celebrity”, a living person, a deceased person), or the like. It is noted that Protected Brand may or may not be protected by a trade-mark and/or service-mark, which may be registered and/or not-registered; however, a Protected Brand need not necessarily already be protected as trade-mark or service mark. Furthermore, a Protected Brand may include a potential or candidate name or brand, that an organization is considering to adopt as a brand, and which the organization would like to check (e.g., in advance) whether it is already being exploited by third parties.

The term “Brand Owner” as used herein may include, for example, the legitimate and/or legal owner of a Protected Brand; or a person or entity who has the legal right to own and/or use the Protected Brand. If the Protected Brand is, for example, a name of a person, then the Brand Owner may be that person himself or herself; or may be entity related to that person (e.g., Ms. Yoko Ono Lennon is the owner of the trademarked brand “John Lennon”). The term “Original Website” as used herein may include, for example, the legitimate website that is owned and/or operated by the Brand Owner in relation to the Protected Brand, or in relation to multiple such Protected Brands.

The terms “Abusive Assets” or “Abusive Domains” or “Abusive Websites” as used herein may include, for example, one or more websites or domains or web-pages, that are not owned and/or not controlled by the Brand Owner, and which abuse or exploit (directly or indirectly) the Protected Brand (or mutations thereof, or other versions thereof), without the approval or consent of the Brand Owner; for example, in the domain name, in the content shown, or by other means.

The term “Abusive Party” as used herein may include, for example, a person or entity who owns, operates and/or controls an Abusive Asset.

In a demonstrative example for the utilization of these terms, the company “Apple Inc.” of Cupertino, Calif. may be the Brand Owner, for Protected Brands such as, for example, “iPhone”, “iPad”, “iPod”, “iMac”, “iOS”, and may operate the Original Website on the domain “apple.com”; whereas, a person named John Smith of Miami, Fla. may be an Abusive Party who owns and operates an Abusive Website on the domain “buy-cheap-iphone-here.com” (or on the website “buy-cheap-cellphones-here.com” while abusing the brand(s) within the content of such website).

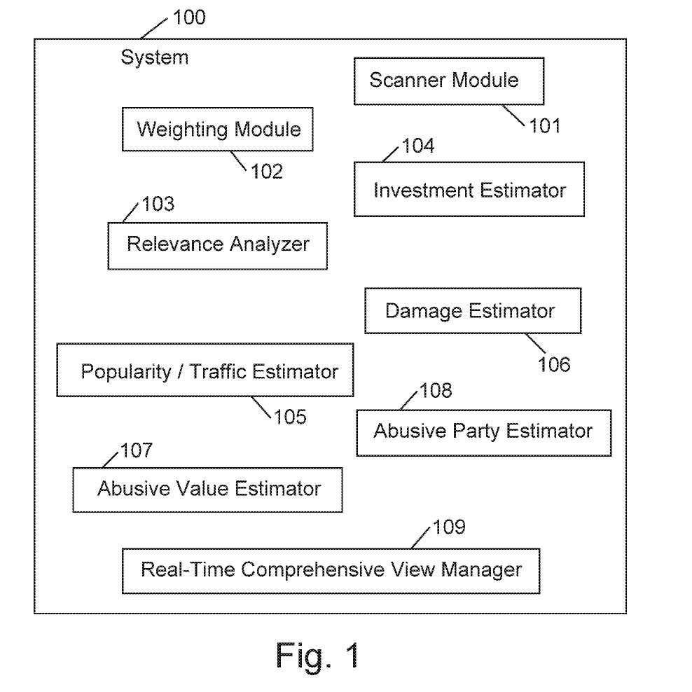

Reference is made to FIG. 1, which is a schematic block-diagram illustration of a system 100, in accordance with some demonstrative embodiments of the present invention.

System 100 may comprise, for example, the following modules or components, which may be implemented using suitable hardware and/or software units: a scanner module 101, a weighting module 102, a relevance analyzer module 103, an abusive investment estimator 104, a popularity/traffic estimator 105, a damage estimator 106, an abusive value estimator 107, an abusive party estimator 108, and a real-time comprehensive view manager 109.

Scanner module 101 may be an automatic and robotic tool able to scan the Internet and measure various parameters that are important for an organization (e.g., Brand Owner) in order to manage its digital brands, and provides updated data and metrics for the protection of such Protected Brands.

Weighting module 102 may weight different parameters and statistical information in order to provide the Brand Owner with the priorities of the risk websites or webpages, that the Brand Owner should enforce its intellectual property rights on, as well as with the priorities of the available domain names that the Brand Owner should register in order to further protect its Protected Brand.

Relevance analyzer module 103 may analyze multiple parameters to create an analysis of the relevance (relative to the Protected Brand) of the risk(s) from Abusive Websites based on their domain name and/or content.

Abusive investment estimator 104 may estimate or measure the level of investment made by Abusive Parties that registered domain names and/or operate Abusive Websites that use or abuse (directly or indirectly) the Protected Brand.

Popularity/traffic estimator 105 may estimate the popularity level and/or the traffic and/or the level of usage (e.g., browsing, searching, online transaction, or otherwise interacting) of an Abusive Website relative to a Protected Brand. It is noted that the popularity/traffic estimator 105 may be responsible for other functionalities, for example, estimating the popularity of a Top-Level Domain (TLD) for the purposes of opportunity analysis (e.g., for deciding which domain names to suggest to the brand owner to register, and in which TLDs).

Damage estimator 106 may estimate the actual and/or potential damage that an Abusive Website created so far, and/or is expected or estimated to create, to the Brand Owner.

Abusive value estimator 107 may integrate different metrics and estimate the value of an Abusive Website to the Abusive Party that operates it; for example, by utilizing data from the relevance analyzer module 103, the abusive investment estimator 104, and/or the popularity/traffic estimator 105.

Abusive pattern estimator 108 may estimate or recognize patterns of trademark infringements and/or brand exploiting websites and domain names and Abusive Websites, in order to better find the parties that perform the infringement or exploitation or abuse, or information that can lead to identifying or reaching these parties.

Real-time comprehensive view manager 109 may generate and display to the Brand Owner a full real-time view of the all the online brand management aspects. Including the risks, the opportunities (available domain names valuable for the Protected Brand), evaluation of current portfolio of websites and domain portfolio management, and/or other features as described herein.

In a demonstrative implementation, a five-step method may be used. It is clarified that other number and/or sequence of operations may be used, for estimating risk and/or opportunities.

The first step may include, for example, creating a database using scanning engines and automatic tools for information collection. The system may comprise scanning engines and crawlers, and automatic tools for information collection that use initial information about the brand that is entered to the system. The scanning tools may include, for example, scanning of domain name registries, scanning of “whois” data servers, scanning DNS servers. “robot” modules that scan online data, tools for collecting statistical information, tools to extract data from different providers of information and data about websites, tools to extract information from search engines and indexes or indices, crawlers that scan and collect the content of websites, tools to collect different Internet ratings, tools that collect information from search engines and/or from ranking sites, and/or other suitable modules. All the information collected is stored in a central database that serves all the modules of the system. Alternatively, distributed architecture may be used, or other suitable architectures may be used.

The second step may include, for example, processing the data collected in the database. The system may utilize automation of data collection and analysis processes that are currently performed manually. The data collected through the brand monitoring processes and the domain portfolio management module is analyzed in order to create an ongoing real-time analysis. The following are two examples for the systems processing of the data:

(a) Processing information collected regarding an existing website: when a domain name suspected to be infringing the brand rights is found as taken, the system will collect in step 1 the information that is posted on the website (the content, titles, tags, graphics, etc.). In the data processing phase the data will be categorized and sorted so that the website will be categorized for example as a Pay-Per-Click advertising website (or “Parked domain”) or as a content website. The new categories and sorting will be saved in the central database of the system.

(b) Processing information about a domain name that the client owns: in phase 1 the system may collect the information regarding each domain name. In the processing phase, for a domain name known as owned by the client, the system may check whether the different contacts of each domain are similar to the default contacts that the client defined. Incompatibilities will be marked in the database and classifications will be attached to domains in which the contacts are not updated.

The third step may include, for example, data analysis using unique algorithms. Different analysis may be performed for the data collected or processed, in order to create different indexes and measures for the different modules and sections of the system—the risk analysis (and within that the pattern recognition section), the opportunities, the optimizations—and within that section the evaluations and monetization, the domain management module and the Brand Check module.

The fourth step may include, for example, presenting the results and data to the user (user interface). This step may include extraction of the data and the different results and analysis performed to a user interface that includes a dashboard, different tables, graphs, pie charts, scores and rankings, and options to perform active actions (such as teaching the system by changing scores, Cease and Desist actions, domain registration related actions, etc.). Optionally, color coding may be used, for example, showing in red items that require immediate attention, and/or showing in green items that appear to be correct and not harming, or the like.

The fifth step may include, for example, performing automatic actions based on the user's decision. For example, the system may utilize tools and/or modules that create automatic and bulk actions or batch actions that the client chose to perform in the system; such as sending bulk batches of Cease and Desist notifications, one-click bulk registrations of all the domains in a certain priority of a new brand the user decided to launch (and used the brand check section for it), etc.

A demonstrative implementation may utilize an algorithm or module having four sub-modules or sub-units, which may be referred to as RPID (relevance, popularity, investment, damage). For example, Relevance Algorithm or module examines or analyses the strength of the domain name and/or the content of the website to the brand; Popularity Algorithm or module examines or analyses the popularity of the website on the Internet; Investment Algorithm or module examines or analyses the level of investment in the website, its development and promotion on the Internet. Damage Algorithm or module examines or analyses the potential loss and damage created to the brand and to the brand owner as a result of the existence of website abusing the brand or as a result of not registering a domain name. Additionally, a scoring algorithm or module weights the different factors and different scores of the above four RPID algorithms or modules, in order to generate a final score for each website and/or domain name.

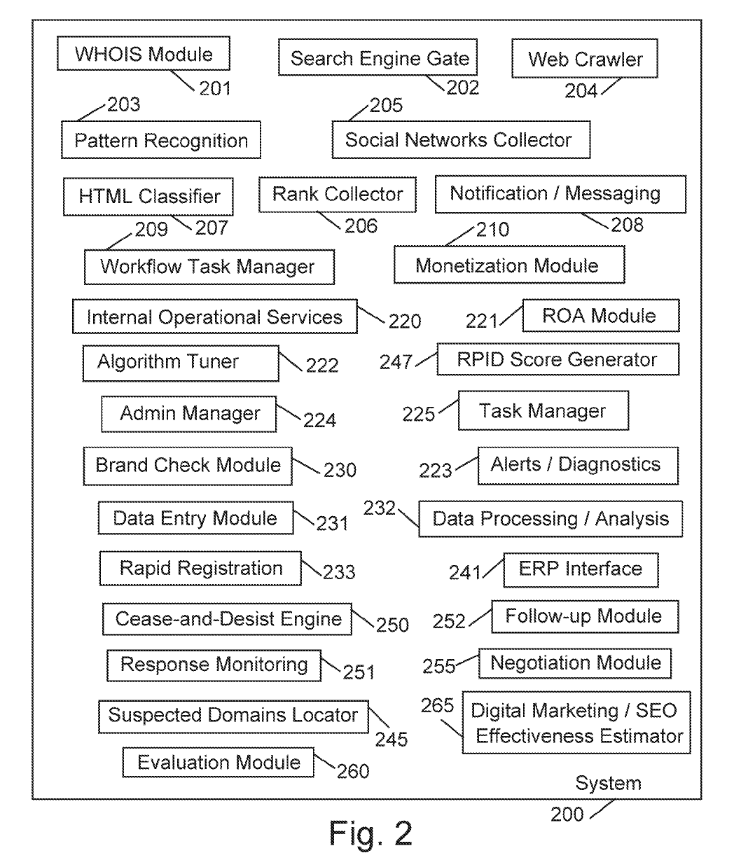

Reference is made to FIG. 2, which is a schematic block-diagram implementation of a system 200 in accordance with some demonstrative embodiments of the invention. For example, in some embodiments, the system may utilize one or more information services or data collection modules, which may obtain or provide information based on the requests of the algorithms and the system's operational services, and based on the information from the user collected by the system. The information collected is transferred for processing and analysis by the algorithms or modules, and the results are then presented accordingly in the GUI. The following are some tools or modules which may operate as internal and/or external information services of the system

A “whois” module 201 collects all the relevant information about a domain name. For example, on whose name it is registered, registration date, expiration date, DNS servers, etc. This component connects to numerous servers that provide this information in order to provide the information in real-time. This component is developed so it can collect the data for all TLDs, namely, the hundreds existing and all those that will be delegated and operated in the future.

A Search Engine Gate 202 provides a central and unified access to search engines and popular websites (such as Google, Bing, Yahoo!, Baidu, Yandex, Twitter, Facebook, LinkedIn, CrunchBase, etc.) through an API. The component may collect the information based on location (search results may vary when a user connects to a search engine from different countries).

A Pattern Recognition module 203 may operate based on information collected through other services (such as the WHOIS content, web crawler, IP finder, etc.), to identify and/or classify patterns among infringing websites in order to recognize repeating infringements methods.

A Web Crawler 204 extracts HTML information from links provided to it; and also collects additional domains for the system by creating a “spider” network from the pages it receives.

A Social Networks Collector 205 automatically collects information from social networks. The service uses different interfaces to social networks (such as LinkedIn. CrunchBase, Facebook, etc.) and/or other social or crowd-based websites (e.g., micro-blogging, Twitter), searches for information and pages relevant to the brand (for example pages that use the brand in their page name, posts that mention the brand, etc.) and collects the information.

A Rank Collector 206 automatically collects information about websites from third party information providers such as Alexa, MOZ, Compete, Google, etc. This information may be used for example for calculations of the Popularity Algorithm.

An HTML Classifier 207 recognizes and classifies the content that is collected from websites. It defines the level of investment in the pages, Search Engine Optimization compatibility, which type of website it is (e.g., Parking, sales, content, etc.). The algorithm may use the service to define the investment indexes and the damage for each website.

A Notification and Messaging module 208 allows sending of system and non-system notifications. The service allows sending a system notification when it arrives as an update, or a system error message, and general notifications that will be sent as email or SMS to an addressee (for example, a Cease and Desist notification). The service allows customization and personal management for each user.

A Workflow Task Manager 209 allows managing authorization processes for the performance of different actions in the system, according to the rules defined by the user. The component allows creating tasks in the system. The tasks can be allocated to a specific user, and the status of the task can be monitored. This service may also enable integration and communication with ERP software products and/or providers.

A Monetization module 210 allows monetizing traffic of Internet users to domain names that are owned by the user organization (the brand owner). For example, this component allows automatic creation of a landing page for a domain name that will provide basic information about the brand, transfer the Internet user to the main website of the organization, or advertise the brand in a different way. The service allows the landing pages to be customized, and to practically create small websites for each un-monetized domain name.

System 200 may further comprise, or may be associated with or may utilize, one or more Internal Operational Services 220; which may collect information from the user and from the system's back-office, provide the information to the systems internal information services and to the algorithms or modules, and present the collected information in the GUI. Additionally, they may provide administrative and management services to the users for all the modules of the system. The following are some of the tools or modules which may be internal operational services of the system:

A Risk and Opportunities Analysis (ROA) module 221 may perform Risks and Opportunities Analysis. The service gets the input of the brand name, relevant brand key words, the website of the brand owner, etc. The service activates the algorithms over the data inserted to it and based on the information it collects from the different system information services. The service may calculate the RPID score(s) and/or the individual scores that together make the RPID score, optionally utilizing an RPID score generator 247.

An Algorithm Tuner module 222 allows the user to perform changes to the score of each website/domain the algorithms ranked. After the changes are performed, the algorithm may learn from the changes and may run again based on the new information.

A Task Manager 223 allows to allocate tasks to different users in the system and to perform a consultation with other users in the system. The service allows to updated progress of tasks, to add comments and notes by users, archive tasks, etc. This service also enables an integration and communication with ERP software products and/or providers.

An Admin Manager module 224 may handle configuration of different settings in the system which are specific for each organization. These settings may include, for example: (a) User Management and roles, a component that may provide a set of definitions of users and permissions; connects between users, organizations and brands; defines which actions are allowed for each user, and to which information the user will or will not be exposed; (b) Billing module, defining account details, credit cards, payment methods, or the like; (c) Brand Section, allows adding brands to the system; (d) Definitions for updates and system notifications.

An Alerts and Diagnostics module 225 samples and monitors the operation of all the system components. It collects updates, errors or other systematic problems that may occur. All the components of the system may report about their normal operation and errors on an on-going basis.

A Brand Check Module 230 may allow an organization to evaluate the level of usage of a brand it intends to launch. The module also recommends which available domains are most relevant for registration. In case the user finds that the overall level of the usage of the brand is low enough and there are enough opportunities for domain registration—the user can choose and register the relevant portfolio of names in a quick (“one click”) process.

The Brand Check module 230 may include, or may utilize, multiple sub-modules or processes, for example:

A data entry module 231 may allow or may handle data entry by the user of a potential new brand. For example, the user enters a brand name or several brands intended to be launched; the user adds relevant key-words; the user defines the relevant countries or geographical regions of activity, the user defines the industry category (if exists); and optionally, the user provides competitors names. It is clarified that the data entry module 231 may operate in conjunction with other functionalities of the system; for example, to allow the user to enter data in order to request a search and/or identification of brand-abusing websites, in order to determine risks and/or opportunities, or the like.

A data processing/analysis module 232 runs an ROA process, similar to a process that would be used if this brand was already owned by the user. The system looks for opportunities (domain names with high relevance available for registration), and it looks for potential risks—including searching for existing domain names with high relevance to the checked brand, looking for websites that use the brand in their content, collecting data from search engines, data providers etc. The system may also scan Trademark databases (e.g., operated by government entities, such as the United States Patent and Trademark Office, or by trademark registrar(s) in other countries; or privately-owned trademark records) to find whether the new brand the user is interested in is already registered as a trademark, or is identical or similar to an existing trademark or a pending trademark application.

An Advisory Report module 232 may generate a report, similar to the report provided in the Risks Module and the Opportunities module(s). The report allows the user to see potential “risks” for the new brand, i.e. websites already using the brand, and to evaluate different opportunities of available domain names for registration. The report may provide in addition the following analysis:

(a) High relevance domain names usage: a general view in percentages of how many domain names with high relevance are taken and how many are available for registration.

(b) Generic level of the brand: a score provided by an algorithm that analyzes how generic is the word used as the brand, based on the distance of the brand from dictionary words.

(c) The level of search for the brand in search engines.

(d) A general analysis of the taken (registered) domain names; for example, how many are with an active website, what type of active website (for example whether it is a Parked domain, e-commerce website, blog, etc.), how many are registered but not active.

(e) Country and language based prioritization; an analysis that generates and shows the level of usage of the brand in different countries (based on the ccTLDs and location of servers) and/or different languages (based on the languages used in the websites).

(f) If trademark databases search was chosen, a report of whether the brand is registered as a trademark (or has a pending trademark application); and if it is—details about the trademark registrations or applications.

A rapid registration module 233 may allow rapid registration of domain(s) by the user. For example, the module allows the user to mark preferred variations of the brand (different strings), preferred countries and preferred gTLDs or gTLD types (i.e. based on industry type). The user may then register all the relevant chosen domain names in a rapid process or in “bulk”.

The Monetization Module 210 may help the organization using the system to quickly find out about domain names that it owns that are not used and therefore are not monetized, and to easily define and launch landing pages or small websites on these domain names in order to monetize them, and make use of potential Internet users traffic to these domain names, and of potential contribution to the overall SEO activity of the organization. The module includes the following components:

(a) A service that checks all the domain names in the portfolio of the organization and finds whether or not they resolve to an active website.

(b) A presentation in the GUI of all the un-monetized domains with the following classification: (i) Domains used for redirection (to another domain name with an active website); (ii) Domains that are entirely inactive (e.g., domains that resolve to a 404 error page or other “website not found” error page, for example).

(c) Score analysis of the un-monetized domains from the evaluations module that allows the user to decide which domains are more important and should be monetized first.

(d) A platform for the creation of landing pages for each domain name that includes the capability to create landing pages to part or all of the un-monetized domain names in a rapid process: (i) A tool that allows to create a template for a landing page, including managing graphic components, the capability for the organization's own design or templates provided by the system. Content management tool, etc. (ii) Capability to create default content and specific structures that will be allocated for landing pages of a specific brand, and/or landing pages of domain names in a specific TLD. (iii) Activating and uploading the websites to the Internet in a rapid process to allow rapid and convenient launching of such mini-websites or landing pages.

(e) Localization capability, including local SEO and/or local translations. For example, performing different SEO operations dedicated for the local language (for example, multilingual capability to edit titles, tags, etc.). Additionally or alternatively, the module may provide multilingual translation(s); for example, automatically sending content for translation to translation providers (that may be selected; and which may be human and/or automated, or a service utilizing both automated translation and manual translation or review); and automatically uploading of the translated landing pages after translation is provided by a translator, through a dedicated interface to the system or an API.

An ERP Interface Module 241 may perform integration of the system with ERP software products, to allow creation of a decision making process for brand protection and domain management, the allocation of relevant tasks, and the management of the relevant budget. The module may include the following capabilities: (a) Complete integration with ERP software; (b) Creation of internal organization decision making process for Brand Protection decisions, Domain portfolio management, and Budget; (c) Adding the capability to perform different activities such as domain registration, domain renewal, sending Cease and Desist notifications, etc. to the ERP software; (d) Permission based access to the system, and other access control measures; (e) Allocation of tasks to different functions in the organization and monitoring of execution of tasks as well as task progress; (f) After authorization of a budget related action, for example, the appropriate internal unit of the organization is debited in the budget; the details of the domain name(s) are automatically updated based on the unit defaults (DNS servers, contacts); and other technical details (such as mail server and hosting records for each domain) are automatically updated based on the unit; (g) customization and permissions management by an administrative party or manager.

Optionally, a suspected domains locator module 245 may operate in conjunction with RPID score generator 247, and may utilize a multi-step method for locating domain names that contain a brand name in their string. It is clarified that a “Domain Name Label” is the part of a domain name which is not an extension. For example, in the domain “example.com”, the string “example” (which is the second level of the domain name) is the domain name label; in the domain “example.co.uk”, the string “example” (which is the third level of the domain name) is the domain name label.

The first step may include, for example, obtaining Public Zone files. The system automatically and/or periodically downloads the domain name zone files of the TLDs registries that make them available for download. The list of domain names that exist in each zone file is entered (e.g., imported) into a database of “existing domain names”.

The second step may include, for example, creation of unique potential domain strings based on the public zone files. The list of existing domain names is sorted and the domain name label of each domain is separated from the extension, to create a list of potential domain strings. For example, the domain “example.com”, in which the domain is registered in the second level, will be separated to a domain label “example” and an extension “.com”; the domain name “example.co.uk”, in which the domain is registered in the third level, will be separated to a domain string “example” and an extension “.co.uk”. Then the list of potential domain strings is sorted. In case identical strings exist, then dilution of duplicates may be performed such that only one of duplicate identical strings will be left in the database, so that the list will only contain unique strings without identical duplicates.

The third step may include, for example, crawling the web to expand the list of existing domain names. Optionally, in some embodiments of the present invention, a Web crawler of the system uses the list of existing domain names in the following way: In order to scan each domain name in the list of existing domain names, the crawler turns to each domain name and downloads the content of the homepage. The crawler scans the content and searches for links (URLs). When a link is found, the system separates the domain name from any sub domain or folders contained in the URL. For example, if the following link is found, http://www.example.com/example_folder/example_file.htm, then the system extracts the domain “example.com” from the URL. The system then checks whether the domain exists in the “existing domain names list”. If the domain name does not exist, then it is added to the list. The crawler then turns to the each URL found, downloads the page and looks for URLs in that page, in a recursive or iterative manner, and so on. The scan process is performed cyclically, so that when the crawler finishes processing all the domain names in the existing domain names list, it goes back to the beginning of the list and searches through the list again, in a recursive or iterative manner. The system optionally performs multiple scans of web-sites simultaneously through multiple servers.

The fourth step may include, diluting the list by removing websites that are known to be (or, are presumed to be) non-infringing due to their general reputation of being a legitimate general-interest website; based on a “white-list” of legitimate sites, or based on other criteria. For example, if the brand being protected is “Disney”, then the search engine(s) may include results such as an article on “CNN.com” about the Walt Disney Company, and this result may be diluted based on the reputation of “CNN.com” as a legitimate website which may be mentioning the brand as “fair use”. In contrast, the search engine(s) may also find a website such as “BuyMickeyMousePants.com” which may not be on such white-list of approved or generally-legitimate websites, and may thus be kept on such list without being diluted.

The fifth step may include, for example, scanning the lists for domains that contain a brand name or its variation. The system uses a String Relevance Algorithm that provides a list of relevant strings which are variations of a brand name and searches the list of Existing Domain Names, and the list of Domains from Search Engines for domains in which the Domain Name Label contains or is similar to the string. Each domain name found is marked as a “Suspected Domain Name”.

The sixth step may include, for example, storing the information collected in a database. In case a domain name that existed in previous search does not exist anymore, the information collected about that domain name is moved to a history database. The history database can be used in future queries of root domain name servers of TLDs that do not publish their zone files, for analysis, statistics, or the like.

Optionally, an automated cease-and-desist engine 250 may handle ceased-and-desist notifications and follow-ups. Based on previously found Risk Websites. i.e. websites, webpages or domain names that potentially infringe or abuse a brand, the user which represents the brand is able to react to these infringements, by automatically or semi-automatically sending Cease and Desist notifications to the registrant of each such Risk Website or other parties and/or contacts listed as connected to that website (such as the hosting provider, domain registrar, etc.).

When the user browses the list of risks in the system, he/she is able to mark one, several or all of the listed Risk Websites. The user may then choose an action call “send Cease and Desist notifications” to parties or owners or operators or other entities that are associated with the selected or marked websites.

The user is directed to a page that presents the chosen Risk Websites, with their Risk Score and other details (such as registrant, date of registration, a thumbnail of the “Print Screen” or screenshot of the page which may be obtained and captured by a web crawler of the system, etc.).

For example, there are different Responsible Parties that are relevant to operating a website. These parties may include, but are not limited to: the registrant of the domain name (the holder), the administrative contact of the domain name, the technical contact of the domain name, the billing contact of the domain name, the registrar of the domain name, the registry of the domain name, and the hosting provider or ISP (Internet Service Provider) of the website.

The system may store pre-defined wordings or templates of Cease and Desist notifications for each of the Responsible Parties mentioned above. The user may compose his own Cease and Desist wordings, use the existing ones, or edit the existing ones to match his needs or to adjust to a particular case. The notification may be sent through email, and/or through regular printed mail. The user may chose the type of Responsible Parties to which he/she wants the notifications sent (i.e. Registrants, hosting providers, etc.).

The user may either browse each notification to be sent one by one for each of the Risk Websites; or may choose to automatically send the notifications in bulk to all the Responsible Parties of the types chosen. The system automatically extracts the previously stored information regarding the Responsible Parties collected for each of the Risk Websites.

If the user chose to automatically send the notifications in bulk to all the Responsible Parties of certain types, the system will automatically add the email address (in case the user chose to send email notifications) or the name and physical address (in case the user chose to send regular printed mail notifications), to the pre-defined wording relevant to each type of responsible party, and will send by email (or print for sending by mail) a dedicated notification for each chosen Responsible Party of each Risk Website. All the emails sent from the system can be stored in a database, and retrieved at any time by the user.

For example, if the user chose to automatically send Cease and Desist email notifications to all registrants and hosting providers of the chosen Risk Websites, the system will automatically extract the email address of each registrant for each of the Risk Websites and will send an email with the wording pre-defined for registrants to each of them separately and automatically, and simultaneously extract the email address of each hosting provider for each of the Risk Websites and will send an email with the wording pre-defined for hosting providers to each of them separately and automatically. Optionally, the user may command the system to automatically send a batch of the emails in a gradual manner, and not at the same time; in order to create a gradual effect or a cascading effect, such that the Registrant receives an email notification on a certain time/date, the ISP receives the email on another time/date (e.g., one day or one hour later), the Administrative Contact receives the email on yet another time/date (e.g., two days or two hours later), or the like. In other embodiments, the user may command the system to automatically send a batch of email immediately, in order to create a “shock and awe” effect towards multiple recipients who receive notification at substantially the same time (e.g., within a few seconds or a few minutes from each other). If the user chooses, he can browse each of the emails and separately before sending, edit each one, and manually authorize the sending of each one.

Optionally, the cease-and-desist engine 250 may comprise a response monitoring module 251, for automatic monitoring of replies or responses. The user defines the email address that will be presented as the Sender of the Cease and Desist notifications, and/or a “reply-to” email address for such outgoing notifications. The user can allow the system to monitor the email box of the Sender (or, to monitor the “reply-to” email address of the sent notifications) for replies coming from parties to which the Cease and Desist notifications were sent. The system automatically scans the emails received in that mailbox and searches for emails received from email addresses to which Cease and Desist notifications were sent. If such an email is found it will be stored in the database and connected to the email sent to that party. Optionally, the system may be configured to distinguish between an automated response email (e.g., an email from an ISP saying “We acknowledge receipt of your email”) and particular non-automated response emails; and the system may indicate with a flag or other indication if the response appears to be automated or non-automated. The user may browse sent notifications with their attached replies. The system may present a table with summaries of number of notifications sent and received replies—for each Risk Website, and a total for all; optionally showing also the date(s) in which notification was sent and/or responses were received.

Optionally, the cease-and-desist engine 250 may comprise a follow-up module 252, which may enable one or more follow-up options for Cease and Desist notifications sent to Responsible Parties. For example, follow-ups can be sent automatically or manually by the system to all parties to which previous notifications were sent. The user can decide on the timing of the follow-up (i.e. a week after the initial notification, a month, etc.), and the type of Responsible Parties to which follow-ups will be sent. The user may select between a bulk wave of follow-up emails, or a gradual or cascaded session of follow-up emails over the course of time. Similarly to notifications, there may be pre-defined wordings of Cease and Desist follow-ups for each of the Responsible Parties mentioned above. The user may compose his own Cease and Desist follow-up wordings, use the existing ones or edit the existing ones to match his needs. The follow-up notification may be sent through email, and/or through regular printed mail. The user may choose the type of Responsible Parties to which he/she wants the follow-up notifications sent (i.e. Registrants, hosting providers, etc.).

The user may browse each notification to be sent one by one for each of the Risk Websites, or may choose to automatically send notifications is bulk to all Responsible Parties of the types chosen. The system automatically extracts the previously stored information regarding the Responsible Parties collected for each of the Risk Websites. If the user chose to automatically send the follow-up notifications in bulk to all the Responsible Parties of certain types, the system may automatically add the email address (in case the user chose to send email notifications) or the name and physical address (in case the user chose to send regular printed mail follow-up notifications), to the pre-defined wording relevant to each type of responsible party, and will send by email (or print for sending by mail) a dedicated follow-up notification for each chosen Responsible Party of each Risk Website. All the emails sent from the system can be stored in a database, and retrieved at any time by the user.

If the system found that a Risk Website was shut-down (i.e. the domain name was deleted and/or the website does not resolve anymore, and therefore no content is available on the Risk Website) or if the website's content has significantly changed (e.g., to the extent that it has a lower level of relevance or no relevance to the Protected Brand), then the system may automatically delete the specific Risk Website from the list of Risk Website for follow-ups; and the system may inform the user that a positive result occurred and that a brand-infringing domain/website was shut down or decrease in its risk score. The system may create, update and maintain a list of Successful Results that resulted from the operations of the system, including the date(s) in which the successful result was detected, optionally storing also a screen-shot or other data capture that attests to the positive result. Optionally, a successful result may be automatically followed-up by the system, after a few days and/or after a few weeks or months, to verify that the shut-down or decrease in risk score was not only temporary or misleading, or did not result from a momentary technical problem of the risk website.

The user may define that if the user allowed monitoring of replies, and a reply to a Cease and Desist notification for a specific Risk Website was received, then the system deletes or removes the specific Risk Website from the list of Risk Website for follow-ups, or otherwise marks the Risk Website as a website that does not require further follow-up for a certain period of time (e.g., one month, or one year).

Optionally, system 200 may comprise a Negotiation Module 255 for automatic Recommendation of Negotiation for buying Risk Domain Names based on historical data. As an alternative to legal activity such as Cease and Desist notifications, dispute resolution processes (DRPs) and lawsuits, the system may automatically recommend to the brand owner to use professional services of negotiation to purchase the domain names that hold websites that infringe the brand or trademark. The system automatically recommends the user which domain names have a higher probability of being purchased easily, and optionally also the price ranges (e.g., when the goal is to use negotiation when expected buy-out price is lower than a prospective cost of a legal action).

A Negotiation Recommendation Algorithm of the system uses statistical and historical data to analyze the probability and price ranges of a domain name being bought in negotiations. The algorithm compares the data of the specific domain, to collected statistics about other domain names that were sold in the secondary market (e.g., of the same Registrant, or of affiliated entities, or of domain names that have a similar string within them). The statistics are based both on historical data of the system, and on external data about secondary market of domain names received from outsource data providers such as domain name marketplace websites (for example afternic.com, sedo.com, etc.) if available.

The information that is being assessed, analyzed and compared by the Negotiation Recommendation Algorithm include but is not limited to the following data: the domain string characteristics (length, generic level of the string, use of popular keywords in the string, etc.), the TLD (whether it is a popular one like “.com”, or a string that is relevant to the type of activity and target industry of the brand, etc.), place or rank in search engines results, the results and data of the Popularity Algorithm (including data about level of traffic, number of incoming links, etc.), the results and data of the Investment Algorithm (including data of rankings from different SEO assessment websites such as MOZ, analysis of the content of the website, etc.).

In some implementations, system 200 may provide the user with unique information, indicating that a risky website, or an abusing website, or an infringing website, is available for purchase in a “secondary market” of domains and/or websites, or through a domain exchange marketplace, or through an auction or a “click-to-buy” domain marketplace. For example, the system may present to the user a list of ten brand-abusing websites; and may indicate or mark or highlight, that three of those ten brand-abusing websites are available for purchase even though they are already registered to third parties. The system may present the requested price for each such “taken” brand-abusing website that the system identifies as available for purchase in the secondary market. The system may allow a one-click operation of the user (e.g., the brand owner or brand manager), to purchase the “taken” brand-abusing websites that the system identified as available for acquisition in the secondary market of domains and/or websites. For this purpose, the system may check, for each brand-abusing domain or website, whether or not it is offered for sale by its owner through a secondary marketplace that allows domain owners and/or website owners to sell, or to offer for sale, their domains and/or websites. This unique feature may allow the brand owner to immediately and effectively dispose of particular “risks” or “threats” to his/her protected brand, by immediately authorizing and/or commanding a secondary-market purchase of such domains and/or websites. Optionally, the system may be linked to pre-stored payment information (e.g., a corporate account of the brand owner; or credit card information), to allow immediate processing of such purchase instructions.

System 200 may further comprise an Evaluation Module 260, which may also be referred to as “Websites and Domain Portfolio Evaluation Module”. The evaluation module may provide the organization with an overall view of its web-sites and domain portfolio and their relative value. The system module presents the owned domain names prioritized by the value they contribute to the brand. It enables the user to see which domains/websites provide the most value and which hardly contribute value.

An Evaluation Score is calculated by an Evaluation Algorithm based on scores of three major Algorithms: The Relevance Algorithm, The Investment Algorithm, and an Evaluation Popularity Algorithm. In addition to the information collected for the measures used in the Popularity Algorithm, the system may collect information and data regarding each website including, but not limited to: (a) Direct Traffic data (either provided by outside data resources that evaluate traffic—such as Alexa and MOZ, and/or by statistical module installed on the servers of the client to collect such data, and/or by services such as Google Analytics that provide search data or analytics data regarding a specific website or webpage); (b) DNS requests data, collected using a DNS data collector of the system that is installed on the DNS servers on which the domain name is defined. The above measures are incorporated into the Popularity Algorithm and are used to create the Evaluation Popularity Algorithm.

The Evaluation Algorithm (and/or other algorithms or modules of the system) may be a learning algorithm. The user can change the level of importance of the web-site, based on his/her own perception. As a result the system will incorporate the user preference into the algorithm for future analysis of results. The evaluation module may allow the user to evaluate the relative values of his domain name and websites. As a result the user can decide to drop (e.g., delete or not renew) domain names that are in a low value, and therefore have small contribution to the online activity of the company. Other algorithms and/or modules of the system may be implemented as learning algorithms, which may gradually learn from feedback of the user, which risks are more important to the user, which opportunities are more attractive to the user, which parameters or metrics the user is more interested in, or other decisions or preferences that may be learned by using machine-learning algorithms.

System 200 may optionally comprise a Digital Marketing/SEO Effectiveness Estimator 265, which may assess the effectiveness and benefit of Search Engine Optimization (SEO) and/or digital marketing (or online marketing) campaigns over time, and optionally in relation to budgets or costs spent for such efforts or campaigns (cost effectiveness).

For example, an SEO Score may be calculated based on multiple metrics, including traffic data, position of the website in different search results of different queries on different Search Engine Websites, number of incoming links, fitness to Search Engine Optimization (SEO) requirements, link closeness to trusted websites such as government websites that measure, content analysis, fitness of titles and tags, incoming links, link closeness to trusted websites such as government websites, rankings from different analysis websites (e.g., Alexa and MOZ) that measure the website, traffic and ad conversion data for the website, data from advertising systems (such as Google AdWords) and similar systems of other ad, data from search engine websites analytic systems (such as Google Analytics), etc.

The factors measured and collected for the analysis of the SEO score may be updated on an ongoing basis based on the different changes of SEO requirements, the different changes in search engines algorithms that affect SEO, and other relevant sources of information that affect SEO and digital marketing.

Consequently, when the SEO Score is measured at time-point T1, and then measured at a later time-point T2, the difference in SEO scores over that time period (between T1 and T2) provides a measurement or an indirect assessment of the SEO activity and/or digital marketing activity of the client for the specific website measured over that time period. If the SEO activity is stopped or modified, different metrics measured as part of the SEO score will be affected and changed, and the score may decrease or increase (if the modification improved the measurements). As a result, the client may monitor and assess the effectiveness of its SEO providers or internal SEO team, and of its digital marketing activity.

Optionally, the system may store data indicating how much money was invested or spent in SEO efforts in each week or month; and the system may automatically generate and show a graph (or other suitable representation) indicating the money spent, super-imposed over the SEO score. The system may automatically deduce that the more money spent (or, a constant amount spent) caused maintaining or increasing of the SEO score; or in contrast, the system may alert the user that even though money was spent on SEO (or even, the SEO budget increased), the SEO score decreased and the user may need to take action (e.g., replace a SEO provider).

As discussed above, the RPID algorithm determines a general risk score based on scores of several (e.g., four) sub-algorithms that are used for the analysis of each potential risk website: relevance, popularity, investment, and damage.

The RPID algorithm ranks and attributes scores to each domain. Its success relies largely on the pool of domains that are potentially risky domains, domains that can infringe on a brand. In order to locate such domains, various mechanisms may be used. Typos or spelling errors are created from the brand name and potential registered domains are identified. Search of the brand within the Zone files and using NsLookup (where the zone files are not identified) are another source. Searches using search engines is another method.

The system may formulate a query which may potentially locate infringing domains. A naive approach would be to simply search for the brand name. Usually the main problem with such an approach is ambiguity, as a brand name that has multiple meanings would yield an unsuccessful query. When checking through the Internet, practically any word may have multiple meanings. The system uses more refined queries that employ specific configuration and integrate external tools.

The Relevance estimator may take into account, for example, domain relevance, content relevance, and graphic relevance.

A Domain Relevance sub-module may determine a score for the domain name based on the closeness or proximity of the Domain Label to the brand, and based on the use of relevant keywords in the string that are either statistically popular or relevant to the brand.

The algorithm analyzes variations of the brand (such as typographical errors, typo-based errors, spelling errors, and/or keyword use). Statistical data regarding the popularity of these variations on the Internet (i.e. their statistical frequency in the list of Existing Domain Names) may be used as part of the algorithm.

A Content Relevance sub-module may be based on collection of webpages that were extracted by the crawlers as a set of documents. A set of queries structured specifically for each brand based on the brand, the relevant keywords for the brand, and the keyword's LSI (latent semantic indexing), are processed on the collection of documents. The queries provide a score that reflects the relevance of the content to the brand and its keywords. These queries reflect the Brand Name prominence, the keywords prominence and the Overall Brand Relevant Words.

In order to create a set of keywords which are characteristic to a given brand, the system may use multiple sources of reliable text which are then formulated into a keyword query. These sources may include Google search and other search engines, LinkedIn company information, CrunchBase company information, brand company owned domains, user input keywords, and other sources. The aggregation of such keywords into a query is done by using a collaborative filtering approach.

Standard algorithms for text analysis often rely on some specific assumptions about the set of documents; for example, that the length of documents is within some rescannable range. However, analysis of documents from the Internet shows that such assumptions are incorrect. For example, length of a webpage can be as short as a single sentence and as long as many volumes. Therefore the system may employ algorithms (e.g., cosine distance matric between a document and a set of keywords), with special adaptation to the structure of webpages.

A Graphics Relevance sub-module may operate using similar framework as above; such that a graphical composition query (that measures the colors, logo structure, etc.) may be processed over the collection of webpages in order to provide a similarity score between the brand owner's graphical composition and the measured webpages.

The Popularity estimator module generates a popularity score based on rankings of different measures such as web-metrics, external tools that provide traffic data, usage statistics, links structure (number of incoming links, internal links, external, etc.), position or ranking of the website in different search results of different queries (such as a query that includes only the brand, a query that includes the brand with one more relevant keyword, a query that includes the brand with different combinations of relevant keywords, a query of major relevant search terms that does not include the brand, etc.) on different Search Engine Websites (such as Google, Yahoo. Bing, etc.), social media popularity of the website and/or webpage (such as the number of “likes” or followers, comments and other “buzz” measures on Facebook and/or Google+ for the page, etc.) and any other data that can provide information about the usage and popularity of the website.

The various sources of information are integrated to get an estimation of the traffic to websites. The popularity score of a website is derived from its traffic and traffic of other websites. A normalization function is used before the popularity score is computed. The normalization function may take into account desired distribution of popularity scores, desired stability of popularity scores, the distribution of traffic volumes to various websites in the internet, and the instability of actual traffic to websites on the Internet.

The Investment level estimator generates a score based on fitness of the website to Search Engine Optimization (SEO) requirements, usage statistics (measures for the interaction of the user with the website—for example, on average a website that has a high investment level may be more engaging to a user than a website with a low level of investment), analysis of the HTML tags structure and the technologies used to construct the website (whether these are technologies that require larger investment of resources, etc.), historical records related to the domain name and its owners (for example a domain that is registered by the same owner for a long time implies a higher level of investment since the domain owner has paid an annual fee for a long time to keep owning the domain), appraisal values (such as from domain secondary market websites, appraisal providers, etc.), visual analysis of the website, etc.

The importance of individual components of investment may be assessed manually, and may also be evaluated based on their prevalence in the Internet. e.g., high occurrence of a feature in the Internet may suggest that it is easy to implement it and it should not contribute much to investment score.

The Damage estimator generates a score that reflects the damage level that can be created to the brand owner from the website. A certain website may have a high Relevance score, a high Popularity score and a high Investment score, yet it might not be a website that is infringing the trademark and/or harmful for the brand. For example a website of a non-for-profit organization of people that have a certain disease that promotes or discusses a certain medicine for the disease may not be seen as harmful for the brand. Therefore the damage algorithm is intended to provide a score that will analyze whether the website is damaging or not.

The analysis may include negative words usage, use of spelling mistakes in the domain name, redirection to advertisements or websites of competitors, type of usage (such as a “parking” site), level of usage of banner ads or other types of online advertisements, usage for improper business or risky business (such as gambling, pornography, sale of alcohol or tobacco or pharmaceutical drugs, etc.), link closeness to trusted websites such as government websites (i.e. how many steps of clicking on links should be made from a trusted website until you reach the measured website), usage of the website for online commerce of products other than the brand owner's products, existence of mail servers for the website (i.e. existence of an MX record in the DNS records of the domain name) which may increase the probability of SPAM or fraudulent emails sent from the website (such as Phishing emails), etc. The algorithm may aggregate information from multiple sources, such as MX-record, Whois data, web metrics, etc. in order to predict or estimate the functionality and/or damage of a website.

Machine Learning: The above features or scores (R,P,I,D) may define the “measurements” which the system employs to rank and score risks. The final score associated with a domain a function of these four scores all, e.g. may be a weighted sum of these features, for example:

Score=Σ_{iε{R,P,I,D}}wᵢ·sᵢ

The weights wᵢ may be defined by expert knowledge (e.g., manually). The specifics of this function may be adapted to any specific user, based on its interactions with the UI of the system. Some actions of the user indicate its dissatisfaction from the current scoring function; user interaction such as cease-and-desist or risk level adjustment, are human indications that may be used as a training set for a machine learning algorithm. The algorithm may take into account the functional form of the scoring function.

New gTLDs Recommendation: New generic TLDs recommendation may be modeled differently from the algorithms described above. Since there is very little reliable data regarding the new gTLDs, a different approach for ranking may be used. The system uses a general framework termed semantic relatedness for ranking the relevance of such gTLDs to a brand. The system may find the extent to which a brand is related to each gTLD linguistically.

Two main approaches may evaluate such a measure: (A) Information Theoretic Measures: Find the co-occurrence of both words in websites relative to the occurrence of each individual word. The assumption is that such a co-occurrence bears linguistic meaning and that search engines return such reliable counts (actually they do not; each search engine manipulates a query in various ways). The “Normalized Google Distance” is an approach for calculating such a measure. (B) Ontological Measures: Use an existing ontology to locate both words, and then employ graph distance as an estimate of semantic relatedness. The assumption is that such an ontology exists. The “Wikipedia distance” is an approach for calculating such a measure.

Since the above measures both have inherent drawbacks, a different approach may be used: (a) Instead of using the gTLD as a string, a meaningful word/expression(s) is used to formulate a query for a search engine. (b) Instead of using the counts of the query result, the links are analyzed. A “good” (efficient, accurate) query should return “good” (relevant, accurate, on-topic) links, along with related searches, images, news, or the like.

The system uses a measure based on the above. For each link a measure of “goodness” or efficiency is defined, based on the mentioning of the brand in the snippet and URL, together with gTLD's words. (c) Known properties of the gTLD and the brand (according to its configuration) are incorporated to get a score more adapted to the brand.

The system may use other approaches, that may rely on all three measures above and navigating around the drawbacks (using different search tactics, rich ontologies and a “goodness” or efficiency measure that incorporates the system's data provided by the user).

A system in accordance with the present invention may be implemented as a computerized platform or web-based service, or stand-alone software/hardware module(s), or as a “Software as a Service” (SaaS) dedicated to Digital Brand Protection and Online Brand Management. Optionally, the system may be implemented in other manners, such as, a hardware and/or software product which may be purchased and then installed and operated autonomously by a brand-owner or a website-owner, with or without subscription service(s).

A demonstrative implementation of the system, for example: (a) Monitors the Internet for sites that potentially risk an organization's brand or infringe its trademarks; (b) Collects a large amount of information from many data sources regarding the site, and automatically prioritizes the risks based on highly sophisticated algorithms; (c) Monitors the organization's own sites using a similar method, collects data, and uses algorithms to evaluate the sites, in order to help the organization; (d) Better manage its portfolio of sites; (e) Evaluate effectiveness of SEO activities; (f) Better monetize its digital assets; (g) Allows automated and intelligent management of the organization's domain portfolio.

The system may, for example: (a) Scan and monitor the Internet for brand abuse—brand and trademark infringement; (b) locate websites that are allegedly risking and exploiting the brand and/or trade-mark or service-mark or trade-name; (c) Measure and collect data about multiple aspects of the suspected websites, including their relevance and closeness to the brand, their popularity, the estimated investment in their development, and the potential damage they can create; (d) Analyze and prioritize the different websites based on their potential risk to the organization; (e) Provide business intelligence for managing the brand online.

The system may provide automatic services for analysis, monitoring and control of digital brand names and domain names management. The system may use web crawlers and data collectors; may provide portfolio monitor and control; handle variety of technical procedures, help minimize damage caused by a problem, monitor security, enable allocation of organizational responsibility, discover trademark or service mark violations (or suspected violations) and forgery and assist in fighting against the violating parties.

The portfolio management module is a module, to which the information regarding the domain names owned by the organization is fed. The system collects data from the web relevant to the organization's digital brands or non-digital brands (e.g., trademarks or brands used by the organization offline and/or online), provides an updated view of current status. The information is analyzed and prioritized, based on common knowledge built by the system experience; gathered from the use by all its users, by cross organizations prioritization and by learning the specific prioritization corrections done by the organization's employees.

The system improves the analysis and prioritization by learning from actions done by the users. It will first learn from the use by operator's employees and later it will be available for use to other organizations. The collective wisdom collected through the use of the system will enhance and adapt the system constantly.

In some embodiments, the system may utilize a module and/or algorithm in order to detect, identify and/or determine cross-brand infringement. In a demonstrative example, the system may collect and analyze data, domain registration data, Internet traffic data, website content, and/or other data and may detect that: (a) a first website, such as “Samsung-Phonez.co.uk” is abusing a first brand that belongs to a first brand owner; and also, (b) a second website, such as “Nokia-Phonez.co.uk”, is abusing a second brand that belongs to a second brand owner. The cross-brand infringement detector module may seek for, and may identify, a pattern among the infringing websites; for example, (A) both of the abusing websites end with the suffix of “phonez” which is slang or misspelling of “phones”; and/or (B) both of the abusing websites contain a name of a brand or company that operates in the same field (e.g., cellular phones); and/or (C) both of the abusing websites are at the same TLD or gTLD or ccTLD, such as ending with “.co.uk” in the above example; and/or (D) both of the abusing websites share at least one common registration detail, or contact person, or ISP, or hosting company, or DNS record, or IP address, or other parameter which may be common to both of the abusing websites. The system may uniquely leverage such cross-brand infringement detection, in one or more ways. For example, the mere detection of such cross-brand pattern, may by itself be used as for further processing and/or analysis by the system; for example, to increase a risk score of each one of the abusing websites that belong to this pattern, or to change their status from “possibly abusing” to “certainly abusing”. Additionally, the system may notify the brand owner (e.g., one of the multiple brand owners that are involved in the cross-brand infringement; or some of them, or all of them) about the detected cross-brand infringement, and may thus enable cooperation among such multiple brand-owners in their subsequent operations (e.g., legal steps, cease-and-desist notifications, DRP complaints, negotiation to purchase, taken-down notices, or the like). This may provide multiple benefits to the cooperating brand-owners, for example, reduction in costs for taking enforcement action; presenting a “unified” stand of multiple brand-owners against a common cross-brand infringer; and an improved ability to prove in a legal process that the abusing websites are indeed abusive in their nature as they infringe on multiple different brands and not only on a single brand. Other benefits may arise from this unique feature of the system.

Some embodiments may include a module for scanning an entire registry of domains (e.g., of an entire TLD registry, for example, “.com”, or “.org”, or “.net”, or “.uk”, or “.de”, or “.trade”, or “.best”, or “.pink”) in order to detect multiple domains and/or websites in that registry, that (A) do not comply with rules that dictate which content is allowed or disallowed in such websites on that registry, and/or (B) abuse a brand name. In a first example, an entire list of domains and/or websites, of an entire registry, may be checked against a list of brand names (e.g., of mixed types, or of particular brand types, such as, fashion brands, computer brands, or the like), in order to detect brand infringement or abuse; and optionally, the RPID algorithm may be used, an RPID score(s) may be generated, for websites that are suspected to be abusing. In another example, the content of such websites on that registry, may be analyzed in accordance with the analysis methods that are described herein, in order to detect non-compliant website content (e.g., pornographic content, illegal gambling content) which may exist on websites of that registry. In both cases, the results of abusing websites or non-compliant websites, may be displayed as a prioritized list or a ranked list, for example, based on descending RPID scores, or based on other score(s) which may measure or estimate or indicate the severity of the brand abuse and/or the non-compliance. The list of websites may be accompanied by action items, as described herein, which the user may selectively initiate with regard to some or all of the websites on the ranked list.

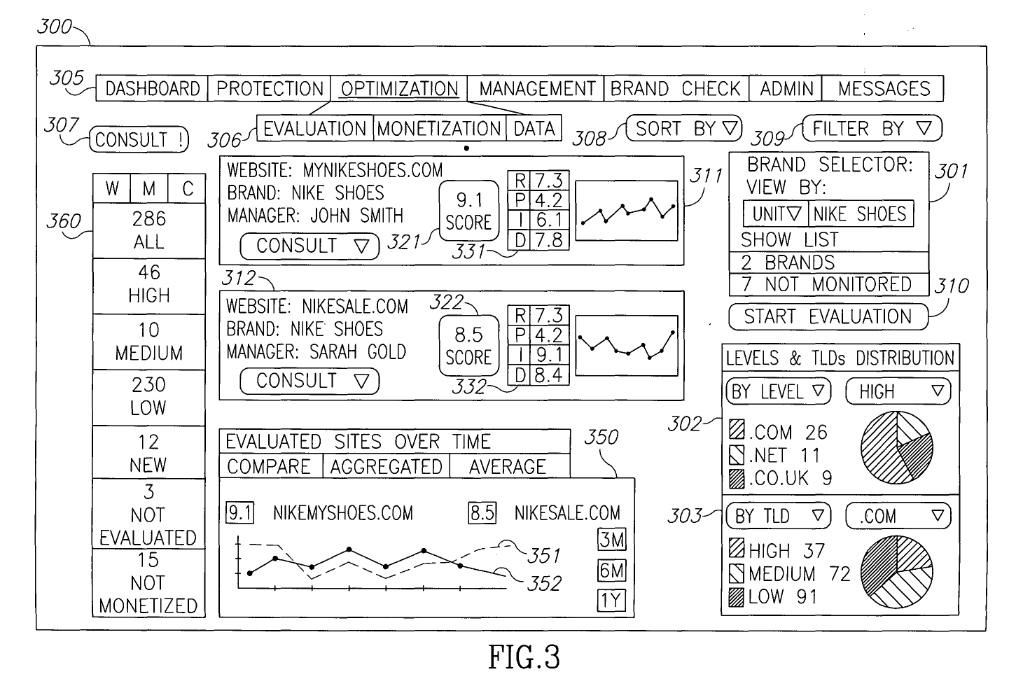

Reference is made to FIG. 3, which is a schematic illustration of a user interface and screen 300 displayed by the Evaluation Module, in accordance with some demonstrative embodiments of the present invention. Toolbars 305-306 may allow the user to make selections or take actions or display portions of the data; buttons 307-310 may allow the user to take actions, for example, consult, sort by parameter, filter by parameter, start evaluation, or the like.

A brand selector interface 301 may allow the user to select a brand for evaluation and data presentation purposes, out of multiple brands that the user may define on the system. A level-based distribution box 302 may indicate the distribution of domains, that belong to that brand, at a certain evaluation level (e.g., “high” evaluation level, or “medium”, or “low”); for example, indicating that at the “high” evaluation level, 26 domains are “.com”, and 11 domains are “.co.uk”, and 9 domains are “.net”.

Similarly, a TLD-based distribution box 303 may indicate the distribution of TLDs related to this brand; for example, if the TLD “.com” is chosen, then the TLD-based distribution box 303 may show that out of all the “.com” domains of this brand, 37 domains have High evaluation level, 72 domains have Medium evaluation level, and 91 domains have Low evaluation level.

Furthermore, multiple domains or websites of the selected brand may be indicated on the screen; for example, a first website or domain 311 and a second website or domain 312; each one associated with a displayed score 321-322, and with specific RPID values 331-332 for each website (or, only RPI values without the Damage score if the items are owned by the brand owner). Optionally, a graph 350 with two respective graph lines 351-352 (or other suitable charting component) may demonstrate the score of each website as a function of time and relative to other websites' scores.

An aggregator data box 360 may indicate additional, aggregated data with regard to multiple domains that are related to this brand; for example, how many such domains have High (or Medium, or Low) evaluation level; how many are “new” and were not yet evaluated; how many are not monetized at all; or the like. The lists and items presented on the screen 300 may be sorted, filtered, and/or searched by using suitable interface components for sorting, filtering, and/or searching.

In the Evaluation module, multiple websites that are owned by the client are concurrently presented on the screen. A scroll down may reveal the next websites in the evaluation level the user views. The line for each evaluated website includes basic information, the score section and a graph showing the evaluation score of the website over time.

A switch allows the user to change the evaluation level of the specific website. The system is a learning system and this switch provides the user input to the system in order to teach the system. The algorithm of the system will learn from such a change in the evaluation level of a specific website and will be updated accordingly.

The score section includes a general score calculated based on each of the RPID algorithms, and the scores of each of the RPID algorithms. Actions can be taken either for each evaluated website separately, or for a group by selecting several evaluation lines and using a general “Actions” button. At the bottom part of the screen, a section showing a more detailed graph of evaluation scores over time is presented. When the user marks one of the evaluated websites, it is added to the graph. Several graphs of several websites can be presented at the same time. The evaluation levels may be presented by using different shades of green for each level, or by using other suitable color scheme. It is noted that with regard to domains or websites that are owned by the Brand Owner, the “damage” component or the damage score may be omitted or ignored or not-calculated; or, an “RPI” algorithm may be used instead of the “RPID” algorithm described above.

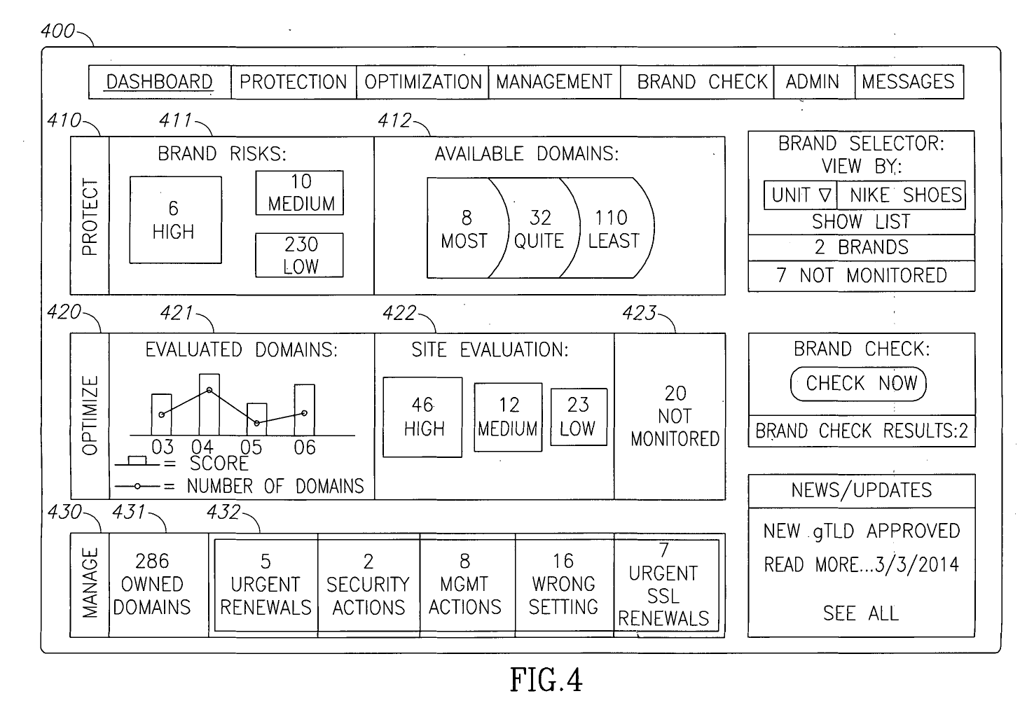

Reference is made to FIG. 4, which is a schematic illustration of an on-screen dashboard 400 which may be displayed in accordance with some demonstrative embodiments of the present invention. For example, Brand Risks may be divided to multiple levels, such as three options of High. Medium and Low. High is represented by the red color, Medium by orange and Low by yellow. Other colors or indicators may be used, and other number of levels may be used.

Opportunities (or Available Domains) may also be divided to multiple (e.g., three) levels of importance. The blue color is used to present opportunities, and levels are presented by different shades of blue, where dark blue represents the most important or highly important opportunities.

Evaluation data is presented in multiple (e.g., three) levels. High, Medium and Low. The green color is used to present opportunities, and levels are presented by different shades of green, where dark green represents the sites with the highest evaluation score.

The GUI may be adjusted to present the data by brand, and also by a business unit. For example, if a business unit has two brands, then a brand manager of each brand may watch the data for the brand he is responsible on; whereas the unit manager may watch the data of each brand separately, as well as an accumulative view of the data for both brands. The administrator on behalf of the client may define the organizational structure in the system, and managers in different levels, are able to watch the data of their different units in both single brand view, and accumulative view (unit view).

The main Dashboard allows the user to watch summary data for all (e.g., three) major sections of the system—for example, the Protection section that includes Risks and Opportunities, the Optimization section that includes the Evaluation and Monetization sections, and the Management section that includes domain, hosting and SSL management data. The numbers of new messages and of notifications may be presented, for example, in a red square over an icon representing notifications and an icon representing messages.

In a demonstrative implementation, for example, a brand selector box 401 may allow a user to select the brand for which data is displayed. The dashboard may include a Protect Pane 410, an Optimize Pane 420, and a Manage Pane 430.

In the Protect Pane 410, a brand risks box 411 may indicate websites or webpages posing high risk, medium risk and low risk; and an available domains box 412 may indicate most important available domains, quite important available domains, and least important available domains.

In the Optimize Pane 420, an evaluated domains chart 421 may indicate how many domains owned be the Brand Owner were evaluated (e.g., per day or per week); a sites evaluation box 422 may indicate how many domains achieved a high evaluation score, a medium evaluation score, and a low evaluation score; and a non-monetized domains indicator 423 may indicate how many domains are currently not monetized.

In the Manage Pane 430, an ownership box 431 may indicate the total number of domains owned by the organization; an Action Items box 432 may indicate one or more to-do items or action items that are due, with particular emphases on urgent or highly-important actions items and the number of domains associated with them (e.g., urgent renewals of domains; urgent renewals of SSL certificates; security actions; management actions; domains having incorrect settings).

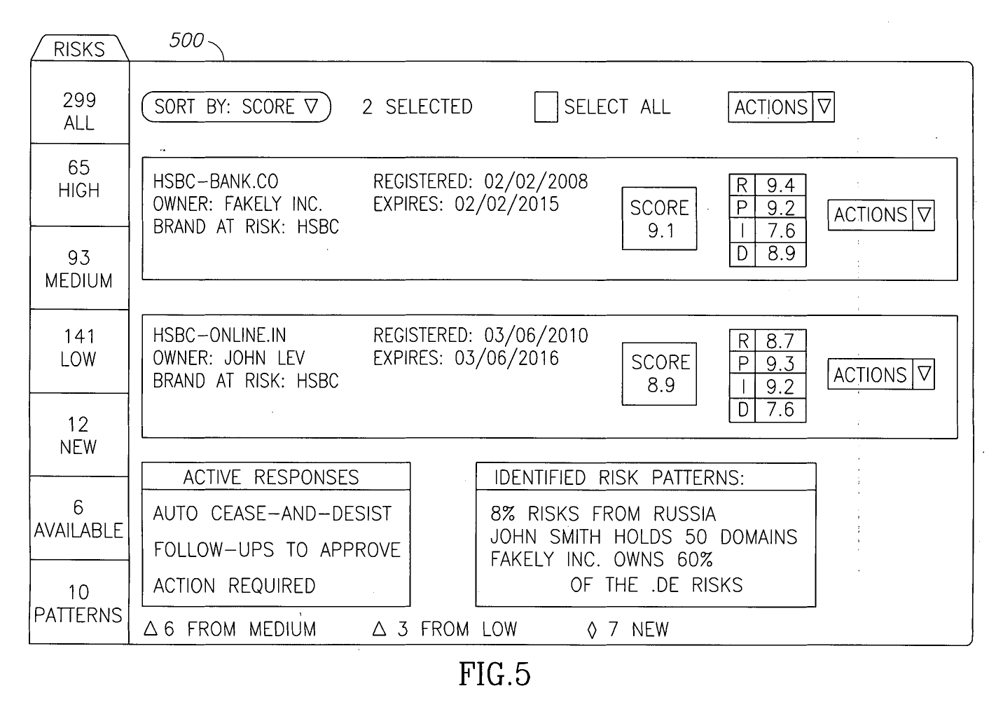

Reference is made to FIG. 5, which is a schematic illustration of a Brand Risks interface 500 which may be displayed in accordance with some demonstrative embodiments of the present invention. For example, multiple risk websites or webpages may be concurrently presented on the screen. A scroll down will reveal the next risk websites or webpages in the risk level that the user views. The line for each risk website or webpage includes basic information, a scaled-down screenshot of the website or webpage, and the score section.

A switch allows the user to change the risk level of the specific website or webpage. The system is a learning system and this switch provides the user input to the system in order to teach the system how to adjust its algorithm. The algorithm of the system will learn from such a change in the risk level of a specific website and will be updated accordingly.

The three risk levels may be defined by colors, for example, red for high, orange for medium and yellow for low. The score section includes a risk score calculated based on each of the RPID algorithms, and the particular scores of each of the RPID components. If the website or webpage was recognized as being part of a group of websites or webpages with similar characteristics (Risk Patterns), then an icon indicating that it is a part of that group may be added in the line of that risk website or webpage. Actions can be taken either for each risk website or webpage separately, or for a group by selecting several risk lines and using a general “Actions” button which may apply to all the selected websites or webpages. Such actions may include, for example: “Mark as Mine”, or “Mark as Not a Risk”, or “Mark as an Affiliate”; as well as, for example, “send a cease-and-desist notification”, or “send a take-down notice”, or “file/initiate a dispute resolution program/DRP”, or “initiate a negotiation to purchase”, or “Flag this website for additional review or handling” (e.g., to appear in a sub-list of sub-group of Flagged Websites). Other suitable actions may be available.

When a user clicks on one of the risk websites or webpages presented, the user may be redirected to a Risk Details Page. The page may include, for example, the following elements or data-items: The RPID scores of the website; a thumbnail screenshot of the website; WHOIS data; DNS records; GEO information such as the IP address, the country it is originated from; the ISP hosting the website; etc. It may include details regarding the enforcement actions that were taken in regards to the specific website or webpage, including Cease and Desist notification, DRP complaint filings, negotiation, take down requests, etc. It may additionally include details about the content analysis, including the brand prominence in the text of the website or webpage, examples for the usage of the brand in the website or webpage, keyword analysis, including top keywords relevant to the brand that were found in the text of the website, traffic and statistics information. SEO measured data, parameters defining the structure of the usage of the website or webpage, whether or not a logo of the brand was found on it, whether or not the design of the website (of particular website components, such as buttons or toolbar) is similar to the designs used by the brand, or the like. In addition, a downloadable full-size screenshot of the website or webpage, date-stamped and time-stamped according to the date-and-time it was captured or scanned and IP stamped according to the IP address of the website or webpage at the time of scanning, and a downloadable WHOIS details page date-stamped and time-stamped according to the time it was scanned, will be available. These date-stamped time-stamped records may be used as evidence in a legal process or in court in case the brand decides to take action against any of the parties related to the operation of the website or webpage.

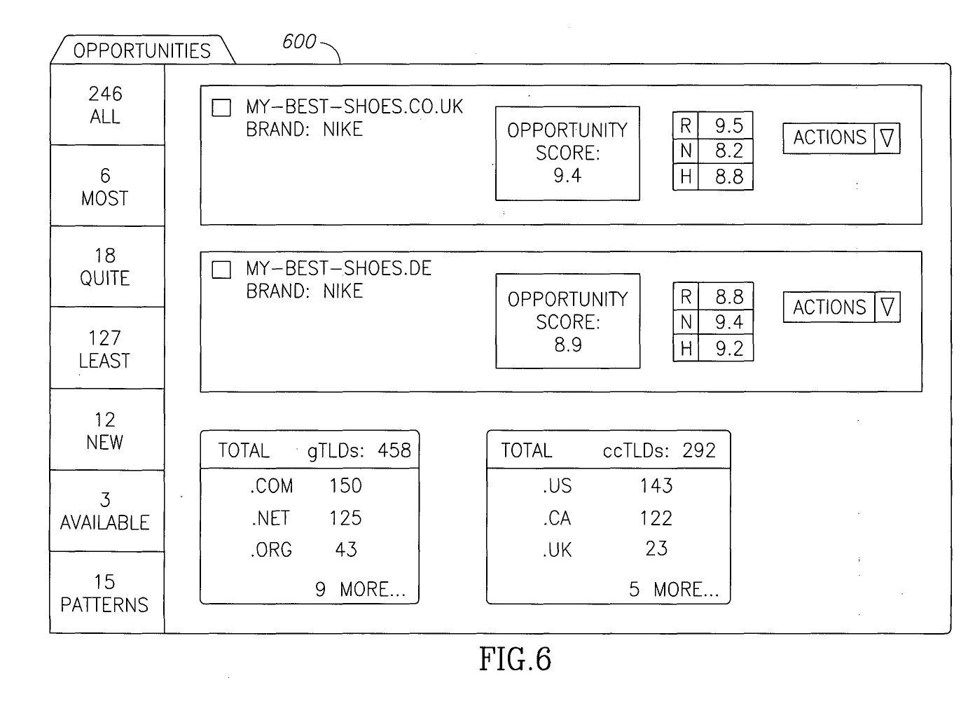

Reference is made to FIG. 6, which is a schematic illustration of Brand Opportunities interface 600 which may be displayed in accordance with some demonstrative embodiments of the present invention. For example, multiple available domains are concurrently presented on the screen. A scroll down will reveal the next domain names in the opportunities level the user views. The line for each domain includes basic information and the opportunity score section.

A switch allows the user to change the opportunities level of the specific domain name. The system is a learning system, and this switch provides the user input to the system in order to teach the system. The algorithm of the system will learn from such a change in the opportunities level of a specific domain name and will be updated accordingly.

The score section includes a general score calculated based multiple algorithms, and the separate scores of each one of those algorithms. Actions can be taken either for each evaluated domain name separately, or for a group by selecting several opportunities lines and using a general “Actions” button. Actions can be, for example, register the domain, add the domain to a shopping cart for purchasing, keep the domain in a “wish list”, etc. The opportunities levels are presented by using different shades of blue for each level, or by using other suitable color scheme.

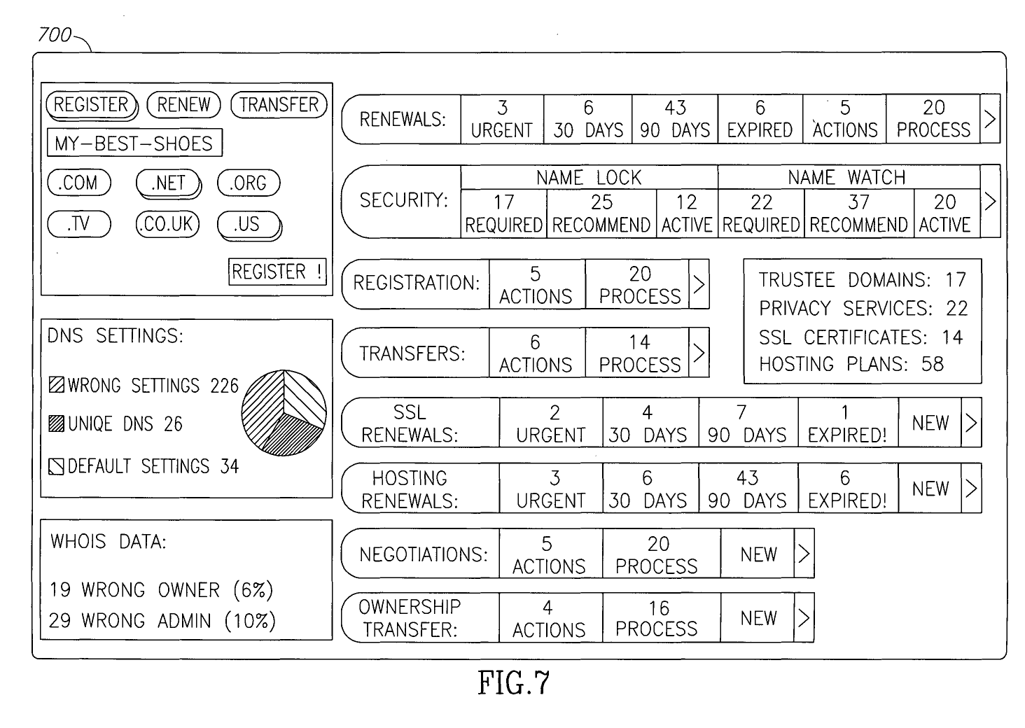

Reference is made to FIG. 7, which is a schematic illustration of Management Module interface 700 which may be displayed in accordance with some demonstrative embodiments of the present invention. The GUI of the management section is intended to present important information for the management of the client's domain name portfolio, hosting, SSL certificates, etc.

The main page of the management module allows quick access to data and groups of required action based on urgency level, based on how close the deadline to act is (e.g., action must be taken right now, or today, or this week, or this month, etc.), based on the estimated budget involved in each action, and/or other classifications or criteria.

The system can prioritize (or de-prioritize) different actions based on the evaluation score of the website—for example, the user can define that when a website with a high evaluation score is up for renewal then it will either be automatically renewed or marked as urgent (even if it is in the low level of priority such as the 90 days prior to expiration date level presented in the screenshot). Other actions can be prioritized (or de-prioritized) in a similar way—for example the use of a security solution such as namelock or namewatch is prioritized based on the evaluation score. For example, websites with a high evaluation score are presented in the security section as “required”, websites with a medium evaluation score are presented as “recommended”, etc.

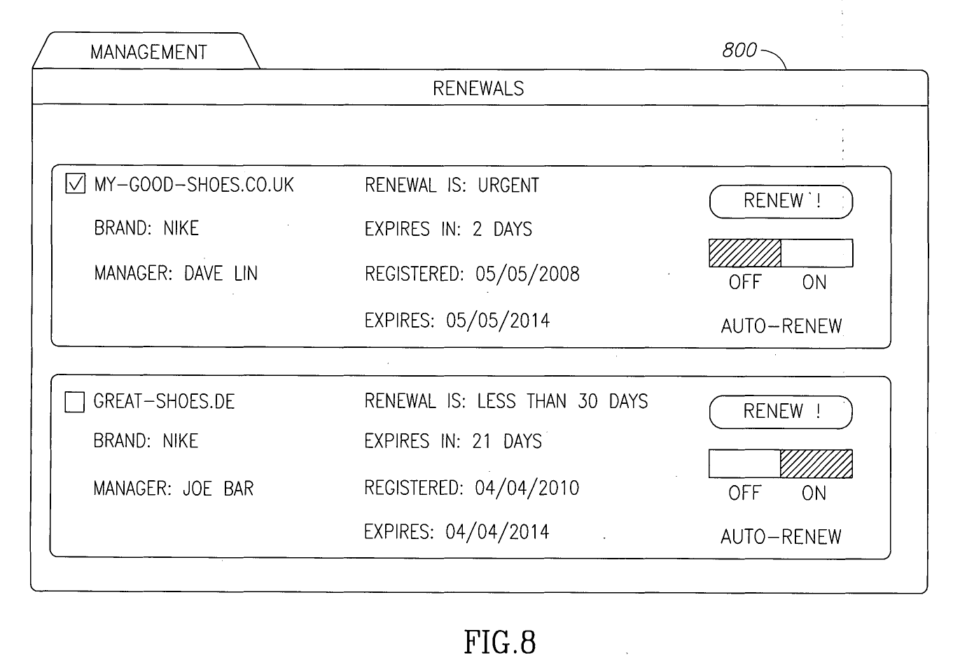

Reference is made to FIG. 8, which is a schematic illustration of Management Module sub-section interface 800 which may be displayed in accordance with some demonstrative embodiments of the present invention. For example, moving from a line in the main page of the management module is performed by clicking the arrow on the right hand side of a specific line—such as “Renewal”. “Security”, “Registration”. The central part of the page is swiped out to the left and the detailed section swipes in simultaneously from the right. The line with the data that was presented in the main page of the management section, is presented as a headline in the top of the detailed section, and the detailed information is presented under it. Clicking the arrow in the headline will swipe the central part back to the main page.

The time left to take actions (such as renewals) is presented in the number of days, and a circle of 30 dots around. Based on the number of days left, an equal number of dots will be colored. For example if there are 21 days left for renewal—21 dots will have color, and the 9 left will seem as colorless. Other suitable methods may be used to indicate the urgency or non-urgency of tasks, or to indicate the remaining time frame until each deadline.

The following definitions and terms may be used, in the discussion herein, in conjunction with some demonstrative embodiments of the present invention.

The Domain Name System (DNS) is a hierarchical distributed naming system for computers, services, or any resource connected to the Internet. It associates information with domain names assigned to each of the participating entities; and it translates domain names meaningful to humans into the numerical identifiers associated with networking equipment for the purpose of locating and addressing these devices worldwide.

A domain name is a name for an Internet Protocol (IP) address of a website. Since IP addresses consist of a combination of numbers, domain names are a way for people to remember where a website can be found without having to memorize combinations of numbers and periods. Some embodiments may distinguish between two parts of the domain name, for example “www.example.com”, which are the Label and the TLD (Top Level Domain).

Label is the name which the domain name owner chooses, which ends with a “.” (a period). In the above mentioned example, the label is the word “example”.

TLD is the suffix that follows the label separated from it by the “.” (the period) and associates it with a zone of the world. In the above mentioned example, the TLD is “com”.

The original top level domain names are known as “generic” TLDs (gTLDs). The “.com” is the most desired because most major corporations adopted it early on, and it became the best known and most relevant. However, if a “.com” name has already been registered, the alternative is to use another gTLD such as “.net” or “.biz”.

The following are some examples of the current available gTLDs: “.com” for commercial; “.net” for network-oriented entities (in the past) or for other entities (at present); “.org” for non-profit organizations; “.int” for international treaties or entities; “.biz” for business entities; “.info” for general usage; “.mobi” for mobile websites; “.tel” for directory of organization's phone numbers; “.jobs” for job recruitment websites; “.musem” for museums; “.travel” for the travel industry; “.pro” for professionals such as lawyers and doctors; “.xxx” for adult-oriented websites or pornographic websites; “.edu” for universities; “.gov” for government branches; “.mil” for military. Additionally, each country may have its own ccTLD or country code TLD.

Domain hijacking is when someone illegally or fraudulently takes your domain away from you. Usually it is accomplished by falsifying a transfer authorization. It can also be done by somebody temporarily changing critical records of your domain such as the managing DNS server records, the A record, or the like.

Domain name speculation is the practice of identifying and registering or acquiring Internet domain names with the intent of selling them later for a profit. The main targets of domain name speculation are generic words which can be valuable for type-in traffic and for the dominant position they would have in any field due to their descriptive nature. Hence generic words, their combinations as well as phrases such as insurance, travel shoes, credit cards, and others are attractive targets of domain speculation in any top-level domain. The speculative characteristics of domain names may be linked to news reports or current events. However, the effective period during which such opportunities exist may be limited. Quick turnaround in the resale of domains is called domain flipping.

The Extensible Provisioning Protocol (EPP) is a flexible protocol designed for allocating objects within registries over the Internet. The motivation for the creation of EPP was to create a robust and flexible protocol that could provide communication between domain name registries and domain name registrars. These transactions are required whenever a domain name is registered or renewed. The EPP protocol is based on XML—a structured, text-based format. The underlying network transport is not fixed, although the only currently specified method is over TCP. The protocol has been designed with the flexibility to allow it to use other transports such as BEEP, SMTP, or SOAP. Not all registries use EPP, and those that do, perform different changes for their own registry, eliminating the standardization of the protocol.

Domainer is someone who registers/buys domain names in order to generate revenues either from traffic of users that are exposed to advertisements (usually Pay Per Click ads, or other types of online ads) or by selling them for a profit. Usually, until these domain names are sold, they are used for advertisements, and are called “Parked Domain Names”.

NameLock is a product or feature of the system in which the settings of the domain cannot be changed on-line, including the DNS servers, the DNS records, and all the domain owner data. A suitable way to prevent a domain from being hijacked is to use the NameLock or other suitable locking mechanism or non-modification mechanism.

Registrar-Lock status of a domain exists when a domain is locked, a domain transfer cannot even be started by another registrar. A domain in registrar-lock status means that the registrar for that domain has locked the domain to prevent any unauthorized domain transfers. Usually the actual registrant has a setting in his account that allows him to lock and unlock his domain at will, for example, through an online interface or control panel.

Parking a domain (otherwise known as domain parking) means pointing a domain name to a placeholder web page which tells visitors that this domain has already been taken. Most people use this feature to provide a temporary page for visitors to see while they decide what to do with their domain. Usually the registrar may provide that page and may use a domain parking system that will exhibit PPC (Pay Per Click) ads (or other ads) on the page. In the case of “Parked domains” the systems and structure of the pages are similar, and these are cases in which “domainers” and others are looking to benefit from the traffic generated to different domain names.

Domain forwarding occurs when a domain name is automatically redirecting a visitor to another website (can be done using HTML or a script to do the redirection, or through the DNS records of the domain name itself). When a domain is set to forwarding a visitor to another page, the domain's name does not stay in the web browser's URL bar. Instead, the new page's URL is displayed, unless a “Framing” script or page is used.

WHOIS (pronounced as the phrase “who is”) is a query and response protocol that is widely used for querying databases that store the registered users or assignees of an Internet resource, such as a domain name, an IP address block, or an autonomous system, but is also used for a wider range of other information. The protocol stores and delivers database content in a human-readable format.

A DNS server or a name server is a server that returns an IP address when given a domain name. This IP address is the domain's location on the Internet.

NameWatch is a product or feature of the system that periodically scans the domain settings by contacting the relevant Registry's database and the authoritative DNS server, looking for any change in the domain setting. Once a change is found an alert is given.

Since sometimes the DNS servers or the registries are not accessible for a short period of time, there are false alarms from time to time. For any change in the setting the customer is contacted to find out if he did the change.

Risk analysis has been discussed above, and may include, among other operations and features, a thorough analysis of all digital brand risks associated with an organization's brands, products and trademarks/service-marks (registered and/or pending) in all relevant countries, including a detailed audit report of its domain name portfolio. In the risk analysis the system may analyze the current and potential risk from domain names not owned by the organization in regard to a specific brand name; and may determine the current and/or potential damage to the brand earnings or to the brand value. This analysis may be done for a group of websites related to the brand name.

Opportunity Analysis determines what may be the potential value of a domain name (that is not owned by the organization) to the brand.

Risk & Opportunity Analysis (ROA) is performed when a new brand is launched or transferred to the system, and updated periodically automatically.

Domain Portfolio Administrator (DPA) is the role dealing with all the administrative procedures resulting from the legal and brand manager decisions, e.g., registrar domain name transfer, registrant domain name transfer, domain name registration, DNS settings, or the like.

In the context of Brand Monitoring, some embodiments may perform: (a) recognition, by using domain data collection (e.g., from IDNs) and semantic content scanning (e.g., including multi-lingual content); (b) analysis, including data mining, pattern recognition, and prioritization; (c) active handling, by automatic responses and/or follow-up actions, and continued monitoring of activity.

The advanced data analysis and correlation capabilities may include: Automatic prioritization of risks and violations based on algorithm; Algorithm for sorting capabilities to locate patterns of violations or infringements or suspected infringements (locate leading cyber-squatters according to different data available); Aggregation of data (e.g., locating all domains violating the brand in the site, in order to ask Google or Yahoo! or Bing or other search engines, to delete or hide the violating domains from their search results). Other operations may be performed as part of the Risk Analysis, as described herein.

The multilingual content analysis may enable: locating of Phishing or Pharming attacks; Locating brand violation within violating websites; Locating slander sites; Locating sites that monetize using the brand (through ads, direct sale, or the like).

The automatic or “one-click” actions according to the analysis may include: Automatic alerts of high-risk violations; Automatic “Cease and Desist” notifications to the domain registrants and to other involved parties: Automatic requests to ISPs and hosting companies to disable violating sites; Monitoring of replies, and automatic follow-ups on requests, all controlled in an easy to use management system; Automation and control of domain transfers (of those that will surrender); Full compatibility for IDNs and different languages.

The system may allow the user to see the information for the whole portfolio or just a specific brand or a group of related brands or to a specific country/zone or a group of countries. In short any filtering of the information. The ROA may be performed on a specific brand.

The system monitors: (a) Domain names that are related to the brand, such as, names in which the brand name and/or relevant keywords appear, including “typos”, spelling errors, typographical errors, and/or other linguistic mutations; (b) websites, which mention the brand name or related keywords in their content with the intention to sell relevant products and/or services, sell counterfeits, commit fraud, or otherwise abuse the brand.

Complete Brand Management and protection may include: (a) Monitoring and fighting web-sites that abuse the brand and/or infringe the trademark: (b) Building the domain portfolio wisely in order to prevent others from stealing revenues (or from monetizing on a brand owned by another entity) and to prevent dilution of the brand or trademark/service-mark; (c) creating the strategy for domain name portfolio management, including prioritizing domain registration of available names, abandoning domain names which do not contribute to the brand, prioritizing for which domain names to activate security solutions, or the like.

Accordingly, in a demonstrative system, a brand protection platform may include: (a) a portfolio/brand overview presentation module (for all the domains relevant to the brand being protected); (b) a risk analysis module (for violating domains and/or violating websites); (c) a digital presence/online presence strengthening module (for identifying available domains having opportunity potential): and in conjunction with the above decision-support modules, ROA process, setting and monitoring, and also supporting a new brand launch based on collected data analysis.

In some embodiments, the main focus of Brand Monitoring is on Taken (already registered; currently registered) domain names and websites. The taken domain names are divided into: affiliates; not active; active websites which may be involved in one or more of the following: (a) redirection to other websites; (b) Competing use; (c) Selling counterfeit merchandise; (d) Containing slander or libel or defamation, or misrepresentations or inaccurate information; (e) Fraud, phishing, pharming; (f) Legitimate (or legal) unrelated use (g) Parked domains that contain ads (such as PPC ads) of different products and services including competing products and services.

Before the system monitors the brand, it may collect data relevant to the brand and analyze it. This process may be called Risk and Opportunities Analysis (ROA). The research of data will produce the following results: (a) A List of all taken domains and their current usage characteristics (i.e. active websites, brand exploiting websites, fraud, PPC parking, redirection to other websites, etc.); (b) the content analysis of each website and the level of its relevance to the brand (c) A table with the investment index and an investment analysis for each of the taken domains; (d) A List of the company owned domains and their current usage (i.e. redirect to one of the company's active websites, inactive, redirects to a PPC parking page, etc.); (e) A list of the company owned domains that have inaccurate contact data; (e) A list of the company owned domains that do not have updated DNS servers' definitions; (f) A table with the Search Trend Index for the main brands in different countries; (g) Print-screen (screenshots or screen-captures) examples of Taken domains, in full size and/or in scaled-down version or thumbnail. Other suitable operations may be performed as part of the Risk Analysis, the Opportunities Analysis, or the Risks and Opportunities Analysis.

Based on the results found in the research, a thorough analysis may be automatically conducted by the system in order to conclude the following: (a) Availability Distributions of researched domains, according to different perspectives: general perspective, priority domain names, and high-risked domains; This analysis allows evaluating what part of the optional registrations with the company's brands is owned by the company, taken by others or available, across the different perspectives. (b) Domain portfolio utilization—the Distribution of the usage of the company's domain portfolio. This analysis provides a view of the level of utilization of the company's current domain portfolio according to the web marketing strategy of the company. (c) Brand exploitation by others—the Distribution of the usage of taken domains and other websites that contain content that abuses the brand. This analysis provides an understanding of the level of exploitation or utilization of the company's brands by third parties. (d) Company exposure in different countries—analysis of the level of exposure of the company across different countries according to the search trends and the current owned domains. (e) Brand security risks—a summarizing analysis of the company's exposure to the different Digital Brand Security risks based on the research results.

The system may distinguish between the following domain names lists: Owned; Available; Taken. Each list is analyzed, prioritized using a different scoring function, monitored separately; and relevant information is presented.

For example, the Owned domain names info may include: current usage (domain portfolio utilization); currently unused—recommended for self-monetization; current security measure used; indication of having inaccurate contact data (domain contacts accuracy); indication of not having updated DNS servers' definitions (DNS accuracy). The Owned domain name analysis results based on evaluation algorithms may assist in making the following decisions: (a) Domain names at risk—need increased security measure; (b) Relative contribution to brand—help in decision how to better utilize and which to abandon.

The Taken domain names info (they are constantly or continuously or periodically monitored for change of use) may include: current usage characteristics; investment index; which of them violates trademark either in the domain or in the content. The Taken domain names analysis results based on evaluation algorithms may help make the following decisions: (a) Domain names to take legal actions against; (b) Domain names to purchase.

The Available domain names analysis results based on evaluation algorithms may help make the following decisions: Which available domains to register.

The ROA may be used to establish the company's Domain Portfolio Management Strategy: (a) Registration strategy—according to availability and brand priorities—creating a list of domains to be registered; (b) Acquisition strategy—according to the current usage and investment index of taken domains and brand priorities—creating a list of domain names to negotiate for buyout; (c) Deletion strategy—in cases of abundant brands, or unnecessary domain registration—creating a list of names that can be deleted from the current portfolio or can be abandoned (e.g., passively, by allowing a domain registration to expire without renewal).

Brand data collection may include collection of the data that may be required in order to perform the risk analysis process regarding a specific brand: (a) Brand name, associated trademarks and slogans; (b) Countries of activity (e.g., countries in which the company has local branches and/or local subsidiaries, or local affiliates, or customers, or intended markets where the company intends to establish local presence or perform marketing activities; or countries in which this brand is marketed; for each country, related local variations of the brands and their priorities; as well as countries in which customers are looking for the brand in spite the fact that the company has no presence there); (c) Domain names related to the specific brand (for example, the following may be required for domain names which are not managed by the system operator: A currently known list of the company's domain names; a list of the company's main active websites; the DNS servers' details that should be used by the company for its active websites; list of domain names used for email accounts; the expected contact details for the company's domains, including (if applicable) the details of subsidiaries and country branches; (d) Keywords relevant for the brand, for example keywords that are search-terms used in search-engines in which the brand advertises itself; (e) Competitors' websites list.

In the research scope definition stage, based on the data collected, an initial analysis will be performed by the system in order to determine the scope for the planned research, including: brand-related domain names; brand-related websites.

In identifying brand-related domain names, the following may be taken into account: (a) Naming variations—listing different variations of the names to be examined, including major misspellings, typos, word swaps, use of hyphens; (b) Researched TLDs—defining the relevant Top Level Domains to be used in the analysis. A function will define which TLDs should be research based on the list of countries provided by the customer, and based on rules defined in the system (for example, gTLDs that should be researched).; (c) The system may propose a set of additional TLDs to be searched, based on a process that finds relevant countries for the brand that were not defined by the user (e.g., utilizing Google trends) or rather; (d) Additional TLDs—the system will have a set of rules and will use tools in order to offer relevant TLDs that the user may miss; (e) The ROA may be done on full list researched TLDs (the system may define all TLDs as relevant for analysis) for all name variations.

In identifying brand-related websites, the following may be taken into account: (a) Violating/infringing and competing websites—a search is also done to find relevant web-sites in which the domain name does NOT contain the brand or a variation of the brand; (b) Analysis of Search Trends for main brands; (c) Analyzing search trends of the main brands as search terms in different languages and countries, in order to evaluate the level of interest in these brands and in order to find possible infringing websites.

The search for relevant websites may be done once every T days. The search will be based on the brand name, the relevant keywords and the other data provided by the user to the system. The system will use an algorithm to filter the resulting list of websites in order to prioritize the risk level of the websites. The relevant web-sites will be presented to the user, and the user will be able to provide its own input on the level of the risk.

The system may know which domain names are owned by the organization. If the system manages the organization's domain portfolio it has this information, otherwise the user will provide the list and system may check it by verifying that the registrant is actually the organization.

With regard to domain names operated by affiliates, not owned by the organization, but have the brand as part of the name: The user will be able to mark for each website whether it belongs to a known affiliate and if so—may have an option to mark one of the following options: (a) The affiliate has permission to use brand related domain names and/or brand related content; (b) The company wants to take over the domain names—mark the preferred action, i.e. let the system operator take care of a transfer process. The brand manager and/or other users who may act on behalf of the Brand Owner (e.g., legal advisor, legal department. IT manager, marketing manager, Intellectual Property (IP) manager, project manager. CFO, or the like) may make similar decisions. For example, the legal department looks for trademark violation and trademark violation preventive actions, while the brand manager looks to better utilize the web for the company interests (e.g., protect from, or stop, or prevent trademark violation, trademark abuse, or traffic stealing with or without questionable trademark violation).

The system may build its own “domain name database”, in order to build and constantly update the system's own database of domain names that are relevant to the brand being protected. The system will have a database of worldwide registered domains, which will be used to find whether a domain name or a variation of it is registered. The database will provide searching with partial name, e.g., search the database to find whether a domain name containing the brand name “Yahoo” exists. e.g. “12YahooABC.com” and of variations and typos e.g. “Yaho.com”. There are public databases which contain lists of registered domain names for specific TLDs; but those databases do not provide the required search capabilities of searching within the domain name.

The system may constantly update this database with every domain name the crawler encounters while searching the net. The system may initiate intentional crawler scans for this purpose. The system may use recursive or iterative crawling. The system may employ learning algorithm to better prioritize the lists. The learning may be from all organizations that belong to the same sector (For example, retail is not the same as non-retail; sales differ from service). The system may fine-tune the leaning based on the interaction done by employees from the same company. In the Taken domain name list, the system may distinguish between violating and non-violating domain names.

In order to fight the “violating” domain names, websites and webpages, the system may look for patterns among violating domain names, websites and webpages. The system tracks the “violating” domain names, websites and webpages for change in activity, analyzing the change. Once an action is performed regarding a taken domain name websites and webpages, it would be monitored by the system more frequently.

Examples of automatic or semi-automatic actions that the system may initiate or take are: (a) Send “Cease and Desist notifications to the registrants; (b) Automatic requests to ISPs and hosting companies to disable (shut down, take offline) violating domains, websites and webpages; (c) Generate legal material, generate evidence showing or demonstrating the violations or infringements.

The system presents the user with a prioritized list of available domains. The user decides out of this list which domains he wants to register. He may register part of the list because of budget limitations, and the rest he may add to a prioritized wish-list of domain names to buy. The system may track the available domain names which the user did not buy, and may notify the user once someone else has bought it and it is in use.

The system may enable one or more processes, which may be initiated and/or performed by a brand manager, an operator of the system, a legal consultant, an automatic or semi-automatic computerized module, or a combination thereof. Such processes (or “use cases”) may include, for example:

(a) Set-up/Update brand ROA scope; the user provides the brand name and relevant keywords and relevant countries and/or TLDs, competitors data, sectors of activity, a list of domain names owned by the organization, etc.; the user may at any time add or change the data: once the ROA set-up is done or updated, the system activates the ROA process.

(b) New brand launch: The system may help the user assess the current status of a new brand name that the organization intends or considers to launch; the system may create an ROA for the intended brand; once the ROA is available the system may support the user in making brand decisions: possibly providing the ROA in parts (e.g., immediate results, intermediate results, and final results) as results are gradually accumulated.

(c) Perform ROA: The system may collect relevant data, process the data and organize it in order to provide detailed reports, presentations and alerts and assist in making decisions regarding websites, webpages and domain names.

(d) Monitor the ROA and update it on a continuous basis.

(e) Make ROA-based decisions; assist the user in making decisions based on ROA results, for example, (1) Which available domain names to register, (2) Against which websites or webpages to activate legal actions, (3) Which taken domain names to purchase and what budget to allocate, (4) Which owned domain names to increase security measures, (5) Which owned domain names to self-monetize and which to abandon.

(f) Consult with another team-member regarding different issues or actions needed.

(g) Approve or provide opinion: allow any employee, even those who are not direct users of the system, to receive a request to approve or consult a decision, and provide the approval or consultation in an efficient manner (e.g., presenting to such employee an approve/reject interface for quick decision).

(h) Retrieve approval/consultation documentation, for previous events.

(i) Start domain negotiation; the user may allocate budget and activate the negotiation process done by the system.

(j) Handle the purchase negotiations; once the customer gave the order and allocated the budget, the system may start the negotiation and document the actions taken and current status of negotiations; the system may send reminders, updates and reports to the user.

(k) Create/update landing page template; create landing page for a specific brand, from several possible pages provided by the system; this page may be used for self-monetization.

(l) Translate landing page; once a landing page was generated in one language, the system may translate it and generate landing pages in other languages.

(m) Monitor legal actions; monitor responses to the sent-out notifications and domain status, provide automatic follow-ups on requests, and monitor domain transfer on those who surrender.

(n) Detect patterns among violating websites or webpages; find common patterns among websites or webpages either violating brand trademark or causing damage to the brand in any other way.

(o) Discover about-to-be-available domains; the system checks daily to find domains related to the brand that are about to become available; such domains may be prioritized and displayed to the user to enable him register them before a cyber-squatter does so.

(p) backorder of Taken domains; and subsequently, backordered domains may be registered automatically by the system to the benefit of the brand owner.

In a demonstrative implementation, the system may perform Set-up/Update of Brand ROA Scope. The system may define the required data for the ROA process, including sector, brand name, language, variation list, relevant countries, main company web-sites and competitors. The process may be relevant for existing brands, for new brands, and/or for brands that the organization intends or considers to launch or to adopt.

For example, User chooses to set-up brand ROA. The system requests: sector, brand name, related key-words/phrases, relevant languages, countries or regions of activity, other relevant main company web-sites; as well as competitor names, their brand names and their main websites. In case the brand name is built from more than one word, the user may provide the brand name parts. In case the domain names are not registered in the system, the system requests the list of owned domain names related to this brand. The user provides the data he/she has. The system may suggest brand/sector relevant keywords/phrases/tags using an algorithm and Internet based resources. The system may present the combined list of keywords/phrases. The user may edit the list adding from the list of suggestions and he/she may delete keywords he/she entered before.

Then, the system generates a list of brand name variation; and a list of keywords to be used in the search of violating web-sites. The system generates the list of TLDs to be used in the analysis, based on countries entered by the user and defined rules (such as TLDs that should be searched, association between country and TLDs, etc.). The system may define all TLDs to be searched. The system associates which name variations will be searched for each TLD. The system may presents a summary of the ROA set-up data. The system may estimate the time it will take before the ROA will be ready. The user chooses to start ROA, and in response, the system starts the “perform ROA” process.

Success criteria for this process include, for example, storing of the following data: Sector, brand name and its structure (in case it consists of more than one word); Search keywords used to search for violating web-sites; Brand main web-sites; Languages; Countries of activity; other relevant countries; Competitors, their brand names and associated main web-sites; for each TLD in the list, which name variations to analyze (e.g., search all variation for all TLDs). The process of data collection may then start. The user may receive a time estimate for getting the ROA results. The list of variations is used to find domain names competing through the use of domain name with the brand; whereas, the list of keywords is used to find violating web-sites (e.g., especially relevant when the brand name is a generic dictionary word, such as “Gap”).

The “Brand Check” process may help the user to launch a new brand for which the organization has no registered domain names yet. The system will help the user understand the current status of a brand (i.e. whether it is widely used or not), to find an appropriate available variation of the brand if needed, so that the brand can be launch with enough associated available domain names, to avoid from future risk of brand exploiting by competitors or third parties, or from the need to purchase many domain names that are already taken and already use the considered brand. Once a name was chosen, the process continues with set/update brand ROA scope.

For example, the user chooses “New brand launch”. The system requests the following details: Brand name or several possibilities; Sectors; Relevant keywords. The user enters details; the user may need help generating keywords, help in coming up with possible names. If the user was unable to decide on a brand or on relevant keywords, the system will generate a list of keywords based on search trends and dictionaries. The user chooses several optional brand names and related keywords he/she wants to check. The system provides the following relevant information regarding the provided brand names: Available/taken domains. The user decides about the brand name. The process continues with “Set-up/Update Brand ROA Scope”. The list of brands may be prioritized. Based on the above or other parameters. The function will give priority to brands in which availability is higher, or if the domains are taken—to those that are used for ads and not active web-sites. Success criterion for this process may be: A brand name was chosen. Optionally, the user may be looking for a brand with available domain names and does not find any brand with enough available domains that he likes; the user may update optional brands, keywords, or the like so that the system will provide an update ranking, until he finds the suitable one.

The process of “Perform ROA” may collect all available required information regarding domain name variations and relevant websites; process the data, using algorithms; organize the analyzed data to be used for reports generation and decision support. The process may utilize crawlers, registries, registrars, and may have pre-conditions: (a) a list of relevant domain names or domain names that are owned by the brand was generated by the system; (b) a list of relevant keywords used to find competing websites that include the brand, was generated and approved by the user.

Once the data necessary to perform an ROA is set in the system the user will initiate the ROA process. The completeness of the data provided may affect the results of the analysis. The system should make this point very clear and support the users in the data collection and entry as much as possible. The system uses a set of crawlers to collect the required data from the web. It requires finding the relevant websites and domains, scanning all of their content, employing smart algorithms to analyze their content. Data collection tools may include: Scan of domain name registries/TLD root servers; Scan of WHOIS databases; Scan of DNS servers (zone files); a vertical web crawler and direct queries in order to retrieve all required information available regarding the websites that are active under the domain names in the list of relevant domain names; a different web crawler with the generated keywords list to find violating websites or webpages that are not in the first list and most likely do not contain the brand name in their domain name; statistical data and other ranking data collected from third party providers

Following the previous steps of the analysis, the system may employ different technologies, tools and methods to perform the following research: (a) Domain names availability; (b) Taken domain analysis. In the Domain Names availability analysis, the process may conduct a search of the set of variation in the relevant TLDs to conclude which domains are registered and which are available for registration. For example, Registered Domains identification may include: (A) Collection of the complete WHOIS data of all registered domain names in the research; (B) Identifying which domains are owned by the company, and which are taken by other parties; even though the user provided the list of owned domain names, the system may verify again which domain names are owned by the company and discover mistakes in the initial data entry; (C) Within the domains owned by the company, perform: (1) Examination of the contacts specified in the WHOIS data and identifying domains names with old data or inaccurate data; (2) Scanning the WHOIS data to identify which domains do not have updated DNS servers' definitions; (3) Inspecting which domains are not in use and which are redirected incorrectly.

The analysis of Taken domains and other websites found in the web crawling process may include: (a) Collection (e.g., downloading) of the entire or partial website/webpage content; (b) Using the website/webpage content, identifying the usage characteristics of domain names with the company's brands that were taken by others—identifying whether they are used for active websites, brand exploiting websites, fraud, PPC parking, redirection to other websites, and optionally generating a Damage score or estimation based on these and/or other parameters; (c) generating Investment Index, by analysis of different Search Engine Optimization (SEO) factors, such as page rank, internal and external links, traffic ranks, etc., to evaluate the level of investment made by the current owners of each of the taken domains.

The analysis of Taken domain and other websites found in the web crawling may use the following information: (a) Web site content—used to identify the use of the website, whether it has slander content, whether it sells products or services of any type (related or unrelated to the brand); (b) Contacts information: (c) DNS server; (d) Whois domain information: registrar, domain status, expiration date, and name servers, contact information for the owner of a domain name or IP, IP and IP location information, web server information, related domain availability, premium domain listings, DNS name servers, DNS records; (e) Analytics data: Page rank, traffic data, traffic rank, SEO index, number of indexed pages in search engines, number of back links, number of outgoing links, is it registered in leading indices, is it registered in social networks and tag websites, how long the domain is registered, until when is it registered, registrar source (black hat/white hat), which technology the website is built in (flash, html etc.), Alexa rank, subdomain information

Each domain name variation is scored with the relevant scoring function (depends on the list it belongs to). The lists are ordered by score. The data is organized so it will be ready to be used for reports and decision support.

The ROA will run periodically. Each time a new ROA is run, its results are compared with previous ROA. The changes may affect the score of domain names and the reports. The system may alert the user about “meaningful” changes. The system may advise the user about possible actions and enable immediate action.

The process may identify and/or react to, the following changes: (a) Change in a registrant; (b) Registrar transfer of a domain name; (c) A significant change of the website's homepage. For example, a change from a parked domain structure to a more “active” website structure—may be meaningful. Moreover, the system may give the user an option to closely monitor specific domains/websites than others; the system will monitor these domains for changes more frequently than the regular ROA monitoring. If an available name becomes taken, then display its current use. If a Taken domain becomes available, then display a list of these names, with analysis of value; the analysis may take into account data collected while the domain was taken. Optionally, the system may include in available names a notification that a particular domain was taken until a predefined time ago. For a domain that was in backorder, inform the user if the system was able to capture it, or in case it was deleted but taken by someone else. Monitor and inform about change of registrant of a taken domain name.

The process may monitor the change of use and content of a taken domain name, website or webpage: From unused to used for ads or website; From advertisement to website; Level of change in the relevance of the content to the brand. Each taken domain name, website or webpage may be characterized as follows: (a) Category of a taken domain name, website or webpage effect on the brand (some categories may co-exist) (e.g., Violating trademark; Competing use: Selling counterfeit merchandise; Containing slander; Fraud/phishing site); (b) Category of uses of a taken domain name, website or webpage (e.g., Landing page; PPC page driving traffic to competitors; Active web-site).

Once the user marked the set of taken domain names, websites or webpages that interest him, the user may request a more frequent ROA update on those domain names, websites or webpages that interest him.

The process of “Make ROA based decisions” may support the user in making decisions regarding his portfolio, specific brand and its related domain names and start the relevant processes, i.e. registration, registrant transfer, domain name parameters update. A precondition may be that the ROA is done or updated. The process may support the user in making any of the following decisions, and provide automatic system recommendations for: Which available domain names to register; Which taken domain names, websites or webpages to start negotiate in order to buy; Which taken violating domain names, websites or webpages to start legal actions; Which domain names need better security measures; How to self-monetization of owned unused domain names (e.g., which landing page to use, or to which website to forward); Which owned domain names abandon (to cancel renewal).

The process may, for example: (a) Prioritize taken domains, websites or webpages by how much they risk the brand; (b) generate automatic alerts of high-risk violations; (c) prioritize the available domains by their potential risk or value; (d) display the use (current use and/or historical use) and investment index of each domain name—this helps predicting how easy it will be to purchase the domain; (e) provide necessary data and documentation regarding brand violation; (f) help decide against which domain names, websites or webpages to take legal action next, by finding groups of violating domain names, websites or webpages that show common behavior (e.g., with the process “fight violating websites”): (g) locate main cyber-squatters against whom additional investigation or legal actions should be taken; (h) Display information regarding available actions and other guiding information; (i) activate or trigger legal actions, such as a Cease and Desist notification, by presenting a standard letter or template, filled with the details of the relevant domain, website or webpage details and once approved sent to all relevant entities.

The process allows the brand manager to easily activate any required process once the decision was made. For example, once the brand manager decides to register a group of available domain names, he will go through the shortest process possible. The system may use the unit default parameter set. The brand manager may decide to go through the process and register the domain names. He may also decide to delegate the responsibility to end the process to other users or team-members who may utilize the system or some of its functionalities.

In some embodiments, the system may include a module which may automatically act as a virtual brand manager, and may take one or more decisions based on pre-defined Rules or conditions that a real-life brand manager or administrator defined in advance. For example, a rule may be, “if the system estimates that a risk domain may be purchased at a price of under 240 USD, then automatically proceed to send out a purchase offer at the estimated purchase price”.

The “Consult” process may allow the brand manager (or other suitable person) to consult with another employee or team-member, regarding any issue that may or may not result in an activity managed by the system. The user may consult other employees using the system. A flow of consultation may not necessarily lead to a specific decision: for example, prioritizing a list of names, evaluating a specific name, or the like. The user may consult another person, which may or may not be a user of the system. The system may create an email message, and allow easy addition of information displayed on the screen, as a report or as a picture. The message will contain a link to page that enables him to enter a simple multi-choice answer and text. The system will send the message. The system will track when a response was provided and alert the user about it. It may send reminders if the user chooses to. The consultation flow is documented and can be retrieved upon request.

The consultation request may be done using a template. The user writes what he wants to consult about; Chooses whom he wants to consult; Adds/points to relevant information; and add the option to Approve or Provide opinion. The process may allow any employee, even those who are not users of the system, to receive a request to approve or consult a decision and provide the approval or consultation in a simple manner. The recipient may get the request by mail. The message will contain all required information. The message will contain a link to a limited access to the system, where the employee will sign his approval or provide some text. The signature or the text will be stored in the system and the system will follow the business flow and generate the required alert.

The process may allow to retrieve decision approval and consultation documentation; to retrieve the documentation of decision approval and all relevant consultation; for example, sorted by dates and including all remarks entered. The user may retrieve by type of decision and/or time span and/or involved personal/organizational role and/or brand and/or domain name.

The system may use a process to start domain purchase negotiation; to allocate budget to buy a taken domain, and to start negotiation (automatically or semi-automatically or manually). The user decides to buy a taken domain name; the user may allocate budget, or may request to start negotiation without allocating budget. The actual negotiation is done by a user, a employee of the system operator or by an automated module. The system may document the dates of action and current status; the system can send reminders, updates and reports to the user, automated or generated by the employee of the system operator.

The system may create landing page template, for specific brand in specific language or for specific country. The landing page may be based on several pages provided by the system with limited ability to change. The user will place details relevant to the organization in the relevant placeholders, e.g. brand name, description, contact details, etc.

The system may translate a landing page; once a landing page was generated in one language, the system (e.g., with automated or semi-automated translation module) may translate it and generate landing pages in other languages.

The system may monitor legal actions; monitor reply to send notification and domain status, provide automatic follow-ups on requests, and monitor domain transfer on those who surrender; supporting multiple languages.

A process may detect patterns among violating websites or violating domains; may find common patterns among websites and domain names either violating the brand or trademark, or causing damage to the brand in any other way. This may typically be performed after ROA is performed or updated. For example, based on the data collected in the ROA, the process may: Find domain names which have the same (or similar) contact details, or similar or recurring details in the WHOIS, or similar or same phone numbers, DNS servers, DNS records, IP addresses of websites and/or DNS servers. The process may examine: A records, MX records, c-name, SOA. The process may look for domains or website that have the same hosting service supplier located in the same hosting farm; the same registrar (e.g., typically a big cheap registrar); Close registration time; Similar website(s): Similar page structure with different content; Check which domain names are registered in the same ccTLD; check whether the owner of the violating domain names may use a proxy. i.e. disguise who really owns the domain names. The process may group together domain names with such similarities. In order to further identify suspicious hints, collect statistics regarding Countries. Registrars. Hosting supplies, and/or DNS servers.

The system may support Brand Administration (or management), by system administrator, brand manager, legal department, IP department, or other suitable user(s). The brand administration module may enable, for example: (1) Allocate responsibility; Define/Update the organizational structure; Assign/update responsibility for a brand to a specific unit in the organization; Assign/update the responsible person in that unit. (2) Delegate brand responsibility; The unit's brand manager may delegate the responsibility for a set of brands that belong to the unit to another brand manager; the process is similar to the relevant part in the process of Allocate brand responsibility. (3) Transfer brand responsibility, from one unit to another. (4) Define/update unit default parameters; a unit has a set of default parameters set for all domain names that belong to the unit; there may be default parameters that are specific for a ccTLD; define this set of parameters, for example, Contact details, DNS server definition, DNS records. (5) Define Alert parameters; define for each alert the default receiver, actions required in case the alerts are not dealt with; alert will be published in the relevant places in the UI, and will also be sent by email, and according to the users definitions—by SMS or voice message. (6) Allocate budget to unit and/or brand. (7) Create business flow, or define flow of decisions/approvals; Define the business flow when dealing with trademark violations and brand violation or other threats to brand from various domains or websites. (8) Monitor business flow; monitor all defined business flow once activated; send the relevant user an alert to do his part on predefined time intervals.

The system may support Domain Administration (or management), by system administrator, brand manager, legal department, IP department, or other suitable user(s). The Domain management module may enable, for example: (1) Monitor/Update DNS server records, including: mail, forwarding, URL, website's IP; allow bulk update for multiple domains or all domains. (2) Monitor/Update one or more domain name parameters, such as, Contact details (administrative, technical, billing); DNS server definition; Password; or others: optionally allowing to change to the default set, or to allow change of parameters not according to the set of defaults, and optionally allowing bulk actions or batch actions on a batch or group of (selected) domains. (3) Add DNS server data collector; to each domain name that belong to the organization and use the system's DNS servers, this may be done automatically; for domains using the customer's own DNS servers, the system may allow to install the DNS server data collector. (4) Mask or hide domain details; Change the contact details so they do not reveal the actual owner of the domain; optionally use a domain proxy holder or owner. (5) Domain(s) registration; Activate registration of available domain; the system will use the default parameters stored for the unit; start the required procedure depending on the country the name belongs to. (6) Activate/Cancel Automatic domain renewal for a domain name; in some cases the system may be able to automatically renew the domain; in other cases it may not be possible, so alerts may be sent to the user and may be shown show in the control panel of the system. (7) Generate and handle domain Renewal reminder; Remind the responsible person to renew the domain registration for which the automatic renew is set to “off”; remind the relevant users or managers. (8) Renew domain; manually start a domain name renewal procedure. (9) Automatic domain renewal; the system will start the procedure of domain name renewal. (10) Domain registrar transfer to the system's registrar (incoming transfer); the user starts the process of transferring the domain from another registrar to new registrar; the user may need to sign paper documents, which may be provided to him electronically. (11) Outgoing Transfer of domain names from the system, outwardly; the user is leaving the system (with regard to a particular domain); an alert to the customer account manager is sent; release domain names, and provide the required items according to procedures. (12) Domain registrant transfer; the user starts the process of changing the domain name owner; the user may need to sign paper documents. (13) Monitor administrative procedures; Monitor procedures regarding registration, renewal, registrar transfer of domain names, and change of domain name parameters; depending on the country paperwork may be required; ensure that all paperwork is done; remind the customer of actions they need to perform. (14) Handle administrative procedures; remind and provide assistance for administrative procedures that require manual work or input from users. (15) Create alerts regarding portfolio administrative procedures; generate alerts regarding portfolio administrative procedures according to pre-set definitions to relevant users at relevant times. (16) Monitor portfolio security; the system displays the list of owned domain names ordered according to their vulnerability; tagging them by: ‘must do’, ‘advisable to do’, and ‘nice to have’ features: the system displays the domain names security measures in action; the user may decide to activate/deactivate services, such as, Domain namelock, Domain namewatch. (17) Perform namewatch; periodically checking changes in parameters of the domain name for which namewatch has been activated, on the registry and the authoritative DNS servers. (18) View billing information; allow the customer to view charges using a variety of filters and views; including subscriptions, renewals, registrations, transfers, one-time payments, recurring payments, or the like.

Some of the processes may require manual feedback or work, depending on the required procedures in a specific country. The user may initiate a process for one or more domain names; monitor the progress of process; get reminders' alerts and get reports. Some processes may act in bulk, on a group or batch of domains, which may be selected manually, or may be selected by filters or sorting (e.g., select all the domains of a certain gTLD, or a certain ccTLD, or select all the domains that will expire in the next 90 days, or select all the domains that were purchased in the last 120 days).

Several procedures always require paperwork and depending on the country some other procedures require paper work: the system will support the required paperwork, including: (a) Store and provide the empty, partially filled forms; (b) Whenever possible fill for the user as many details as possible; (c) In case the system cannot fill the form, provide options (e.g., the system will appoint a user or a system operator employee to print the form, fill what he/she can, scan it and upload it to the system and then the system will alert the customer a form is awaiting for his signature and maybe some other missing fields he/she needs to fill; the customer will print the partially filled form, sign, scan and upload it to the system; or alternatively, the user will handle the form without help from the system administrator); (c) In any case the customer needs to print the form, sign, scan and upload; (d) The system will provide reminders until the procedure is done; (e) The system will keep the history of all actions done in the process and provide the ability to retrieve the history and the filled forms; (f) In some cases, a re-confirmation or re-approval may be required by one or more managers in the organization is required; this may be done using a predefined business flow.

The system may allocate brand responsibility; may allocate or update brand responsibility, of brand to unit, and the default responsible person in the unit; allows defining the responsible person for a specific brand. There may be one default parameters set per unit.

The system enables to define/update part of the organization hierarchy; this is relevant to the unit in charge of one or more brands including actions regarding domain names. The system allows defining: units in the organization; organizational roles; employees and their organizational role and responsibilities in the system; brand names; permissions; who is responsible for which brands. The organization may be divided into units; a unit is responsible for one or more brands. The user allocates responsibility for brands to brand managers. This brand manager should be defined in the organizational hierarchy. The admin may define the permissions allocated to brand managers.

The system may allow to Transfer brand responsibility, from one organizational unit to another or from one person in the same unit to another. The system may allow to Delegate brand responsibility, from a first brand manager to a second brand manager in the same unit. Optionally, an Organization hierarchy editor module may be used for the above processes; to handle, create or modify: hierarchy of units, organizational role, organization employees (some of them may be system users, and some of them may not), brands and their association to units, permissions, person in charge of brand.

The system may allow to Define/Update unit default parameter set: to Define/Update the set of required default parameters for a unit. In ideal situation, each domain name under the unit responsibility will have the same set of parameters. Many organizations have registered the domain names on employees that no longer work for the organization and they are unable to track those people: the system prevents the organization from doing several actions, in order to avoid future problems, and the system allows to manage the domains in an orderly manner using default domain name parameters. It is advisable to have all domain names that belong to a specific unit have the same set of parameters. A particular ccTLD may have a default set of parameters that is different from the unit default set. The ownership of the domain should belong to the organization and not to an employee or the organization owners.

When registering a new domain name under a specific unit, the set of default parameters for that specific unit and TLD will be used. The user may change the parameters. When the organization starts using the system, the user defines the default parameters sets. Once a brand is added to the portfolio and the ROA is executed. An important outcome is marking domain names of which some or whole of the parameters differ from the default set.

Each unit which is responsible for domain names will have a set of default parameters. The default parameters include the following groups: (a) Contact details, registrant name (the owner), administrative contact, technical contact and billing contact; (b) DNS servers definition; (c) DNS records. A record, MX record, Cname. SOA, mail, URL forwarding, website's IP, etc.). In some implementations, the status default parameter is locked, and the user may not be allowed to change that.

The DNS records definition are not based on defaults most of the times; but there may be occasions when the user will want to use the DNS records definition of a main website or when the user registers a bulk of domain names. The user may choose to have for some of the domain names a different set of parameters. The user will mark each parameter the user intentionally wants to be different from the default set as such. Once the list of default parameters is set or updated, the system will update those domain name parameters that used the default. Before making the change all the changes will be displayed to the user. The user may decide not to apply the check of domain parameters for some or all domain names. Change of registrant may require signing forms, change in other contacts requires additional authentication either by providing a password of the domain, or by clicking an authentication link in an email that is sent from the system after the change was performed. The system may have a “contacts book” in which each contact is defined. All uses of this contact point to the relevant entry (nic) in the contacts book. A change of any of the contact parameters will affect all references to that contact.

The system may define Alert Parameters; may define for each alert the default receiver, when to send another alert.

The system may allocate budget in any level of the hierarchy to lower levels; in some organization each user is able to define his budget, in other organizations managers in a specific level may allocate the budget to their subordinates. The system may allow it both ways, to allocate budget to one or more brand managers or legal personnel. The allocated budget is for a specific set of brands, based on the organizational hierarchy.

The system may create a business flow, or a chain of decisions and/or approval(s) necessary to make a specific action. The customer organization may define the required procedure in order to execute certain decisions and/or actions. The procedure involves the approval of an ordered list of organizational roles. The organizational roles need to be defined in the system, but the employee holding them may not need to be a registered user of the system. The system may support this procedure. It may be a chain of required digital signatures (approvals), or may involve consultation before decision is made. The system supports by providing the required procedure, alerting and reminding the employees about the waiting task and documenting the actual actions done. The organization may define any procedure for any actions done by the system.

The customer admin and/or the system admin may define a business flow. The consultation and approval flow is documented and can be retrieved upon request. Possible decisions include, for example: Domain names registration; Domain names renewal; Domain names abandoning (i.e. cancel renewal); Domain names purchasing including maximum amount to close deal; Budget allocated to buy a domain name; Change of prioritization of domain names and websites lists including: violating/owned/available domain names; “Cease and Desist” actions: DRP complaint filing; Other legal actions; New brand launch, whether to launch a specific brand based on the ROA the system provided; Decide on Self monetization of domain names.

The business flow may have a condition attached to it. In this case it will be activated only when the condition is true. Once a business flow is defined the relevant use-case will support that business flow. For example, if a business flow was defined that the registration of domain names needs the approval of the Unit Brand Manager, the activation of domain name registration will include this approval. The system will support approvals by someone who is not a user of the system. The details of that person, including name and email address, will be defined in the system using the organizational hierarchy. Once the person's details were entered this person can be part of any business flow. The approval request of non-user will be done in a similar way to consultation with someone which is not a user. Each user who makes or approves a decision can add a note to the decision. The process may utilize the organizational hierarchy. The user chooses: which decision, for which unit, optionally sets a condition and chooses the list of organizational roles. A condition maybe set for more than one business flow, or for more than one decision. The same business flow may be defined for several decisions. The process may be associated with a process to monitor a business flow, once activated; and send to the relevant user an alert to do his/her part at predefined time intervals or milestones.

The system may Monitor/Update DNS records of domains owned by the organization: including: mail, forwarding, URL, website's IP. Allow bulk update. The system may Monitor/Update domain name parameters, for example, check and update if required the definition of authoritative DNS servers and the admin. technical, billing contacts of one or bulk of domain names, usually in order to correct errors found in domain names' registration parameters. This may allow changing the domain names' contacts and the definition of the authoritative DNS servers to the unit default set—this is advisable and prevents many problems that might arise later, but a specific organization may decide to act differently.

For the above processes, for example, the system displays the current parameters, marks the errors and offers a change to defaults when available; the system enables the user to accept the defaults and prompts the user for manual actions when required: then, the system enables the user to edit the parameters or to leave them as they are and to mark them as correct. In this case they may not be checked any more against the default set and changes to the default set may not affect them.

The system may allow to add DNS Server Data-Collector. Part of evaluating a domain name is the traffic that this name generates. This can be done on domains owned by the organization by collecting statistics. The user may allow to install a statistics collector which may reside on the DNS server or on the web-server hosting the website. This may be done automatically as a result of a user action, to enable collecting statistics on traffic and/or DNS requests; and may allow to place statistics collectors as part of self-monetization.

The process of Mask Domain details may allow to change the contact details so they do not reveal the actual owner of the domain. The organization may wish to hide its connection to certain domain names. The domain may be registered under the proxy service provider details, which acts on behalf of the real owner as “proxy”. This can be done in TLDs that allow it. The details that will be updated in the public WHOIS data are of proxy owner; while the real owner data is stored separately.

The process of Domain(s) registration may register available domain names. Preconditions may include: The default parameters for the unit are set; a decision has been made which available domain name to register; All required approvals have been signed. Special cases for this process may be, for example, Registration by trustee, and Registration of masked domain.

For example, the user searches for available domains, or the system presents the list of domain names to be registered that was previously decided and approved in the case an approval is required. If in the meantime some domain names are not available anymore (someone else has registered them) then this will be marked to the user. The user will mark which domain name need to be masked. The system will provide the defaults when available.

The user approves the default or creates new parameters, or chooses different parameters for: contacts from available contacts' lists; Authoritative DNS servers from available DNS servers; DNS records. The system presents information regarding the process. If form filling is required the system guides the user what the user needs to do. The system handles the billing, according to the agreement this customer has. The user decides whether to have automatic renewal. Success criteria for this process may include: The administrative process of domain registration has started; The user printed all required forms; The registration was billed to the customer; The status of the registration process is updated.

The system may Activate/Cancel automatic domain renewal, or may change the automatic renewal parameter. In case the domain owner wishes to abandon a domain name the user will make sure the automatic renewal is “off”. In case the user wants to make sure the registration will be renewed the user will set automatic renewal to “on”. In some cases the system will be able to automatically renew the domain. In other cases it is not possible, so alerts may be sent from the system to the user to deal with the required paperwork, or to the system operator employee so that from the customer point of view this will be done automatically.

The renewal reminder process may remind the responsible person to renew the domain registration for which the automatic renew is set to “off”. The organization defines who gets the reminder alerts. Optionally, the process may make the renewal reminder message look as if it came from the organization administrator. The process may also allow manual renewal of domain registration for which the automatic renew is set to “off”.

Automatic domain renewal may allow the system to execute domain name renewal where possible. This may not require any customer involvement. Where manual action is needed the system may send email reminders and control panel alerts to perform the renewal.

The system may support domain registrar transfer into the registrar operating the system of the present invention. Preconditions may include, that a decision was made which domain names owned by the organization and registered with another registrar to transfer to the target registrar.

The process of domain registrar transfer varies from one TLD to another; therefore what is required to start the process varies. The process is handled for each domain name separately. The information regarding what the user has to do for each set of domain names that has similar procedure is presented in a clear and concise way. The system may automate the process as much as possible. The necessary forms that need to be filled and or signed will be presented. The user will decide if he/she wants to deal with them now, if not the system will remind the user later about it. Another process may be triggered, to monitor the status of all administrative procedures and remind the users to do their tasks. The system will store the date of transfer and the ordering organizational role of the customer

The procedure may require from the customer one or more inputs, for example: Provide the user name and password with the current registrar; Sign forms: Handle it by himself/herself. The system may allow the user to read the instructions for the transfer; and to have tasks added and/or completed by the user.

The system may support Domain registrar transfer away from the current registrar, to release such domain to a different (external) registrar. A precondition may be, that the domain name is owned by the organization and registered with the registrar running the system of the present invention; and that a decision was made to move the domain name to another registrar.

Depending on the country there is a defined procedure regarding registrar transfer. The system will alert the system operator, who may first inquire to find out whether it is a decision made by the organization or another entity is trying to hijack the domain name. If it is the organization decision, it may inquire about the reason. If he/she is convinced that the organization wants to move the domain name to another registrar, the system may unlock the domain to allow the registrar transfer. The process may also allow domain registrant transfer, to start the process of domain registrant transfer, i.e. changing the owner of the domain for which the organization is the current owner.

The system may allow to monitor portfolio administrative procedures, that are not immediate. Relevant procedures include domain registration, domain renewal, registrar transfer, domain purchase negotiations. The system may provide guidance for required steps, provide required forms, display transfer status and remind the customer and administrator of required actions.

There are several administrative procedures which may take hours, days or weeks to complete. The system provides the user easy access to see the status of ongoing procedures and generates alerts/reminders to the relevant user(s), who can modify the frequency of reminders. The alerts may include alerts to other employees/managers in the organization and/or to system administrator when the procedure is “stuck”.

Such administrative procedures may include: Negotiation to purchase taken domain; Domain registration including registration under escrow; Transfers to the present registrar running the system; Domain renewal; Update of DNS definitions; Update of contacts update. The system may handle portfolio administrative procedures; and may remind and provide assistance for administrative procedures that require manual input or actions. The system may allow to create alerts regarding portfolio administrative procedures; and may send alerts regarding portfolio administrative procedures according to pre-set definitions to relevant users at relevant times.

The system may monitor portfolio security: and may display security status of owned domain names and decide which changes in protection measures are needed. Protection measures available may include, for example, Namelock and Namewatch. The decision regarding protection measures is based on the brand priorities, domain usage (i.e. active websites in contrary to redirections), and exploitation level by third parties. For domain names scanned under name secure, the system may display: number of domain names; number of DNS servers scanned; geographical zone(s); News regarding attacks; Explanation and tips to increase the security. The NameWatch module may check periodically that no changes were made in critical domain parameters, and may notify user(s) if such changes occurred.

The billing information module may allow the customer to view money spent using a variety of filters and views, including subscriptions and one time payments.

The system may comprise a Brand Optimization module, which may enable or perform: (a) Domain portfolio evaluation, to provide the organization with an overall view of its digital portfolio and its value; and (b) Self-monetization module to start making revenue out of owned unused or misused domain names, by putting them into use.

The Domain Portfolio Evaluation module may provide the organization with an overall view of its digital portfolio and its value. The system may display the owned domain names prioritized by the value they contribute to the brand. The system enables the user to see which domains provide the most value and which hardly contribute. The user may apply filtering to the data.

The Self-Monetization module allows to utilize owned unused domain names; and optionally to add statistics collector(s) to them. The preconditions may include: the list of owned unused or misused domain names exists. The system may display the list of unused domain names decreasing score. The user will decide for each domain how to best use it. The options are, for example, to set a landing page (choose an available template or create a new one and add the relevant parameters), or forward to an existing brand web-site.

Setting a landing page may require the user to enter the default landing page for the specific brand and language/country, or choose from predefined set of templates of landing pages. If no landing page is available, the user will get a message and can create one. The templates may have the following in place: Contact information; Product/service short description and benefits; “about us” page; Logo; optionally, pictures of the product. The user may choose to enter the template editor and edit the template or the data therein.

The system may alternately forward a domain to a target web-site; if the forward address is defined then it will be used. Otherwise, the user may be prompted to enter it and asked whether this should be the default.

The system may include a History Module, for keeping and tracking all data in a database to make advantage of history data. One implementation of this capability is keeping information about a risk website over time, so that a report that provides information about the evolvement of the website can be provided, including but not limited to the use of different keywords in the content of the website over time, the time-stamped screenshots of the homepage or other pages of the website over time, the time-stamped WHOIS data and changes in WHOIS over time, positions in search engines over time, number of external links over time, different scores time, etc. Information of website is also saved in a history database in case the domain name was deleted (and therefore the website operation was terminated). Such information can be later used by the algorithms of the system, for example to determine whether that website has a higher opportunity score, since it was previously used. Such capabilities may be available in all modules of the system, such as risk module, opportunities module, evaluation module, monetization module, affiliates module, domain management module, or the like

The system may utilize multiple algorithms and modules geared to support decision regarding: (a) Which taken domains, websites and webpages are violating the brand or the trademark; (b) Which violating domain names, websites and webpages to start legal actions against: (c) Which available domain names to register: (d) Which taken domain names to enter in purchase negotiations; (e) How to self-monetize unused owned domains: (f) Which owned domain names to abandon (i.e. they will not be renewed); (g) how to deal with trademark violating (or brand abusing) websites, webpages and domain names.

In an ROA setup module, for example: The user provides the brand names, keywords, slogans, logos, and other trademarks. The user provides the main websites used for those brands. Those websites and the websites pointed to from those websites may belong to the positive list. The system may help by suggesting relevant keywords or tags. The system generates the list of brand name variations (the list may not be presented to the user) that the use of them may be considered as brand name trademark violation.

In a module for finding potential violating domain names, websites and webpages and extracting their content, for example: The system maintains domain name database which is constantly updated (a different algorithm). The system will use the previously mentioned domain name DB and other ways to find all domains names, websites and webpages that are potentially violating the trademark and the brand. All domain names found in the generic TLDs will be searched in all other TLDs. Those websites may be presented to the user which might dismiss some of them and help the system learn the “trademark and brand violation rules”. The system will use a vertical crawler to get the website content of the violating domain names, websites and webpages. Optionally, the system may obtain the keywords from the main website content. The system will use another web crawler that will use the brand name and keywords to search for websites (for example through queries to search engines) that potentially violate the brand name and trademark. The system will use a vertical crawler to get the website content of the potentially violating websites.

In a module for finding violating domain names, websites and webpages and prioritizing them, for example: (1) The pages extracted in the previous steps will go through the following classifications: Containing trademark violation and brand abuse including Containing slander. Selling counterfeit merchandise, Fraud/phishing site, Monetizing brand name; classification based on the Type of use. The system may distinguish between legitimate affiliates and violating domain names, websites and webpages. The system may distinguish between two aspects for each violating domain name, web-site or webpage: How much traffic is “stolen from the brand”; and how much damage is done to the brand. The system will extract from each page that is classified as violating the page component that contains the violation. This will be presented to the user, who may accept or reject or change the level of the assessed risk. The page components are saved with all relevant data as a piece of evidence. The websites containing trademark violation (in the domain name and/or in their content) will be scored using a scoring function. The score will be used to present a prioritized list of violating websites, webpages and domain names. The system may identify patterns between violating domain names, websites and webpages. This will help in optimizing the effort put into fighting against them.

The risks module may have the following characteristics: (a) its input is a list of domain names owned by the brand and related data; (b) the rank of each domain name is a weighted function of a set of scoring functions (indices) relevant to the specific list of domain names. The scoring functions are further discussed herein. The risks module may utilize keywords suggestion—such that, given a brand name and optionally additional keywords related to the brand, the system will suggest additional keywords. The module may further use a Name variations generator—given a brand name and relevant keywords, the relevant domain names will be generated in two ways: (a) names generated from search results using Google (or other search engines); (b) Names generated from the brand name and relevant keywords directly, e.g., by use of hyphens, major misspelling mistakes, “typos”, spelling errors, typographical errors such as change of letters order, word swaps, spelling mistakes, find common mistakes in searches from web tools, suggest other keywords, transliteration from English to other languages, translation of meaningful names into other languages, or the like.

Similarly, TLDs suggestion may be made; given the list of TLDs provided by the user, the system may offer to add TLDs; for example, the system may have a set of rules regarding the set of TLDs to be used in the ROA, and/or the system may use tools such as Google trends.

The risk module may further perform, for example: Scanning the web to find violating websites and webpages, for each suspected website and webpage, asses the level of violation. Scanning the website content to find whether this website is performing any of the following against the customer brand (Competing; Selling counterfeit merchandise; Containing slander; Fraud, phishing, pharming, redirection to competitors, brand abuse, etc.). Analyze website/webpage content to assets its use: active website, PPC, etc. Analyze website/webpage content to determine SEO investment. Compare the content of selected website pages to discover changes in its use.

Sources of information regarding domain names may include, for example: Initial data collected on the web; system's statistics collectors—relevant just to pages and websites that reside on the servers that employ the system's statistics collector; Owned web-sites generated statistics, for example by using Google Analytics; Learning based activities. The above mentioned sources will be collected when relevant on specific user, different users from the same organization in a specific role, different users from the same organization any role, different users from different organizations that belong to the same sector in the same country.

The brand name score function may help the customer choose a new brand name or register domain names for a current brand. The score is based on the availability of relevant domain names for registration purposes or domains that might be purchased. A generic set of scoring function of an existing website may include, for example: (a) Domain name index: “Generic name” level—how close is the name to a dictionary word; “Similarity metrics” to brand name; “Similarity metrics” to a predefined set of keyword relevant to the brand; “Similarity metrics”—between brand name and a variation; This function measures how close a name variation to the brand name is. The name might be contained spelled with a typo, add a keyword, use competitor name, etc. (b) number of appearances in searches; (c) Traffic index; (d) number of DNS requests; (e) Conversion index; (f) Type of use index: redirection to other websites, PPC parking, active website—violating or not relevant; (g) Taken-used domain name—investment in SEO, based on: Spider view index—process the fields used by search engines: title, description, number of words, number of keywords; Title index—“relevance” between title to brand and relevant keywords; description index—“relevance” between description to brand and relevant keywords; Meta Tags index—“relevance” between Meta Tags to brand and relevant keywords; HTML source code index—degree of HTML source code structure suitability to SEO requirements; Parking index—for a parking site—degree of pages structure suitability to existing structure of parking sites, is the IP address in the range of one of the leading Parking sites; Advertisements index—based on the existence, quantity and quality of advertisements

The value of available domain names may be determined based on: Domain name index, such as, “Generic name” level, “Similarity metrics” to brand name, and “Similarity metrics” to a predefined set of keyword relevant to the brand; Past Traffic index; number of Past DNS requests; Conversion index; Type of use, such as, not-used or used in the past for forwarding or active website. A weighted score function using the above mentioned scoring functions may be used, in order to prioritize the list of relevant available domain names.

The score of websites and webpages may be based on: (1) Name index, such as, “Generic name” level. “Similarity metrics” to brand name, “Similarity metrics” to a predefined set of keyword relevant to the brand; (2) Analytics index (popularity)—traffic rank, page rank, number of indexed pages in different search engines, number of outgoing and back links, is registered in leading indices, is registered in social networks and tags websites, How long is the web-site registered and until when is the current registration, Black hat/white hat registrar, type of technology used by the website (HTML, Flash, etc.); (3) Investment index—based on analysis of website structure, such as, (a) Spider view index—relevance between title, description, keywords and meta tags; (b) number of words, number of keywords; (c) HTML source code index—built for search engine requirements; (d) Parking index—similar to parked domain structure, IP address in the range of parked domains companies; (4) Type of use index, such as, Competing/violating/not relevant, or forwarding/Landing page/Parked domain/website; (5) Advertisements index—based on the number of ads and their similarity to the brand and keywords. A weighted score function using the above mentioned scoring functions may be used, in order to prioritize the list of taken domain names

In addition to the above mentioned score for websites and webpages the following may also be processed: (a) Detecting and documenting trademark violation and brand abuse within the website content; (b) Find patterns between violating domain names, websites and webpages (regarding the same brand and between all brands in the system) in order to locate cyber squatters; find one entity using a big bulk of domain names, websites and webpages violating the brand; (c) Find patterns of violating domain names, websites and webpages in order to speculate which domain names might violate in the future and buy them in advance, as “Bid the squatters”.

The value of owned domain names may be determined based on: Traffic—collected in the organization websites; DNS requests—using statistics collector installed on the DNS server wherever possible; Analytics indices; “Generic name” level; “Similarity metrics” to brand name; “Similarity metrics” to a predefined set of keyword; How long is the website in the air; Investment in SEO index; Type of use index: Conversion rate index. A weighted score function using the above mentioned scoring functions may be used in order to prioritize the list of relevant owned domain names

In order to help the legal personnel decide which domain names, websites and webpages to deal with first the system will try to find the owners/operators of a big quantity of violating domain names, websites and webpages.

Some embodiments may utilize a multi-step algorithm. Initially, the system asks the user for input: a Domain, a Brand, some Keywords, and possibly for some relations between them; and optionally the list of countries of interest.

Then, the system may search for suspicious domains/websites which may abuse the brand. Sites/domains that are known to belong to the user are excluded from the searches. Firstly, the search is made (in the existing domains list—provided by Domain List Manager Module) for domains with highest Similarity Metric to the Input; TLDs are set by using the data collected from the user; the output of this step is an ordered list of domains. Then, search is done (using Search Engine Agent Module) for websites relevant to the user input.

Then, Scores and Indices computation is performed, to set scores for the websites residing on the domains found in the above steps using a Website Analyzer Module. These scores may depend on previously computed ones, website data (obtained from Website Crawler Module), and data received from third party websites or other external sources.

Then, ranking computation and user output may be performed. The domains. Websites and webpages found will be presented to the user, ordered by the scores determined above, configurable to some extent by the user.

Optionally, the user may guide or assist the system via supervised learning techniques. The user may designate a class (e.g., High, Medium, Low) and the system may recalculate a new weighing scheme for the different scores. For each domain, website and webpage, the user may have access to detailed information, some of the most relevant scores, and may leave feedback on them, which may then be used by the system to teach the learning algorithms used in distinct Modules.

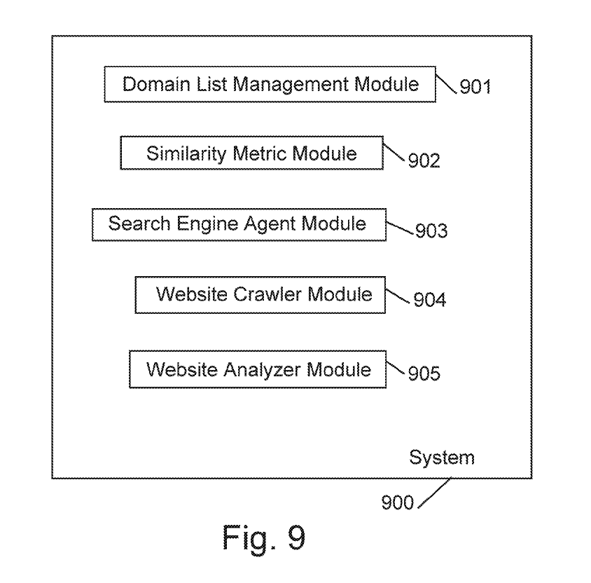

Reference is made to FIG. 9, which is a schematic block diagram illustration of a system 900 in accordance with some demonstrative embodiments of the invention.

System 900 may comprise a Domain List Manager module 901, which makes and constantly refreshes the list of all registered domains known to the system. Sources may include zone files, data by partners, or brought by automated WHOIS queries or custom-made crawler.

System 900 may further comprise a Similarity Metric module 902, which determines how much a given string is “similar” to a brand with its keywords; and may account for misspellings, hyphens, word orderings and similar perturbations. Metrics include: known typical typing mistakes; various additions (such as adding a character or adding a global or brand keyword), permutations (such as inner hyphen) and/or typographical errors.

System 900 may further comprise a Search Engine Agent module 903, responsible for finding sites or other relevant information about brand abuse, using search engines queries. For example, a corpus of text is produced. The text is passed on to a natural language processing tokenizer which may remove all “stop words” (words used for sentence structure only, like “the” and “and”). Keywords are calculated from the output of the tokenizer. The agent includes multiple Google and other search engine queries and the use of services such as Google Trends (or similar) API.

System 900 may further comprise a Website Crawler module 904, which crawls and fetches or reads all the relevant data from a website. The full HTML source is extracted from each website. Since the full HTML contains different elements which are not related to content, such as styling and scripting tags, such elements are parsed and filtered. The filtered content is passed on to a natural language processing tokenizer which is used to remove all “stop words” (words used for sentence structure only). A histogram of relevant words is produced for each website, optionally using a Website Text Histogram module.

System 900 may further comprise a Website Analyzer module 905, which generates one or more scores for a given domain/website/webpage. These scores may depend on, for example: Domain Properties (Name. TLD, WHOIS, IP); User Input (brand, domain, keywords); Data extracted from the page contents using the Website Crawler Module; Data received from some search engine queries using Search Engine Agent Module; Third-party sites providing data about the domain/website/webpage via API or other interface; some scores may depend on each other. See below for more concrete data-source specification.

The scores may be one of the following: abstract integer or real numbers (e.g. 158.34), percentages (61.5%), real world units (10 visitors per hour), qualitative estimates (high/medium/low), binary (yes/no), or classification elements (Parking/Commerce/Other).

Some of the scores may have a special role in subsequent process, for example: Selection score is the one used to select top N domains from the full list to present to the user; Default sorting score is the score by which these N domains are to be sorted (probably the same one); UI scores—are all the scores to be shown to the user.

The scores may include, for example: Domain Similarity Score; moz data such as mozRank—also called “domain authority”, obtained using free MOZ API; Alexa API; WHOIS data; Homepage data; Google queries positions or rankings; site relevance score.

The site relevance score may be produced in the following manner: (1) The website crawler produces a histogram of content based words; each website is treated as a text corpus; (2) A vector space model is produced, i.e. a term document matrix with TF-IDF (term frequency—inverse document frequency) scores; a feature space is produced using the document-query model; the queries used as features include, for example, Brand name query and Brand keywords query.

The scores may include, for example: Relevance score, Popularity score. Investment score. Damage score (“RPID” scores). Each score may be calculated based on several sub-scores.

For example, the Relevance score may be determined based on: domain similarity; keyword occurrence in the website (with separation among title, tags, and text); mega-tags; inbound links (based on search engine data); keywords balance.

The Popularity score may be determined based on: data from traffic measuring sites; data from traffic estimation sites; PageRank data; search engine results and/or ranking; how generic is the domain; important outbound links; outbound link to brand-owner website; outbound link for Investor Relations or other suitable sites or pages.

The Investment score may be determined based on: known owner identity; value of the domain at domain marketplace(s); estimated investment in Search Engine Optimization (SEO); technologies used (sophisticated and expensive; or simple and inexpensive); domain registration date; domain expiry date; website type (e.g., static, redirecting, other).

The Damage score may be determined based on: negative words; competitor names or links; spelling mistakes; online commerce; parking site; ads are present; improper business; brand exploitation, brand abuse, existence of MX (mailserver) record, redirection to competitors sites.

The data sources for generating the above scores may include for example: data from the Similarity Function Module (SFM): data from the Search Engine Agent Module (SEAM); data from the Web Crawler Module (WCM); data from API of the relevant site or automatic hot usage; data from WHOIS query to the relevant registry regarding the domain name; data from a relevant Dictionary file (such as, US-English).

The Crawler may create a database of domain names for each TLD. Lists of domain names are available only for few TLDs. For each domain name found the system will check whether a domain name with all different TLDs exists. For taken domain names with active website relevant to a specific brand—several levels may be used: get the home page; get the full website content; get pages via outgoing links. Optionally, a Registry Interface may be responsible for automatic interface with all domain registries.

The system may be implemented as a collection of web services that provide high performance and scalability. Services are deployed using SOA architecture basics. Examples of web services subsystems include: Task Manager, Search engine gate, Billing service. Domain aggregator. Rank collector, WHOIS and Zone file retriever. These subsystems or modules may communicate through secured fully authenticated web service calls. The presentation layer may include a web client, a smartphone client, and a tablet client able to communicate with the other subsystems through the same web services accessing the same resources and performing identical functions.

The architecture allows for performance improvements by providing the ability to deploy services on different web servers. The server components themselves may be deployed on different servers as well. The SOA architecture provides easy adoption to client's data and provides high scalability. For example, many web servers may be added to support the rising number of users. Sticky sessions can be used on each web instance.

The database is designed in a partitioned architecture. Each partition will handle a different set of ROA'S and users using alphabet rules. The architecture allows for performance improvements by providing the ability to deploy the same services multiple times on the same servers.

Data Recovery Ability: the system may have an equivalent data center for data recovery purposes. A load balancer router may direct the users to the secondary data center should the first one stops to respond. Continues replication should exist between the storage from both data centers.

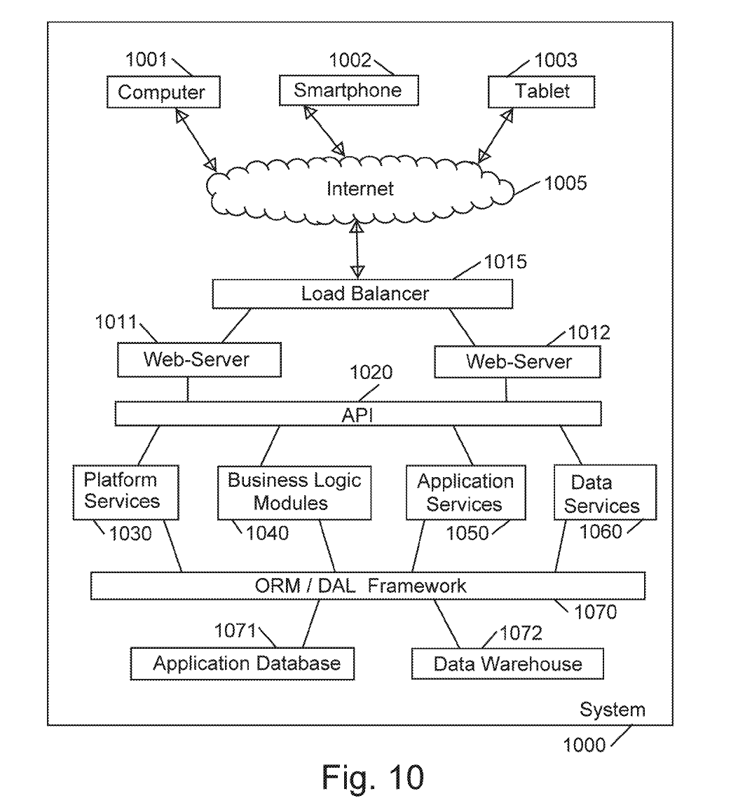

Reference is made to FIG. 10, which is a schematic block diagram illustration of a system 1000, in accordance with some demonstrative embodiments of the present invention. System 1000 may include multiple client devices, for example, a computer 1001, a tablet 1002, and a smartphone 1003 (other suitable electronic devices may be used); which may communicate over wireless and/or wired communication links (e.g., through the Internet 1005, through HTTP or HTTPS connections) with one or more web-servers 1011-1012 (or a batch or farm of web-servers); optionally utilizing a load balancer 1015 to route communications to a particular web-server. The web-servers 1011-1012 may use an API 1020 to interface with one or more platform services 1030, for example, business logic modules 1040, application services 1050, data services 1060. Optionally, Object-Relational Mapping (ORM) and/or Direct-Access Layer (DAL) framework 1070 may be used to connect with applications database 1071 and/or data warehouse 1072.

The business logic modules 1040 may include, for example: task manager; algorithm tuner; user management and role module; self monetization module; notifications and messaging module; administration module; portfolio management module.

The application services 1050 may include, for example: domain aggregator service; algorithm service; ROA service; HTML classifier; billing service.

The data services 1060 may include, for example: Rank collector service; web crawler; WHOIS service; search engine gate service; zone file retriever service.

In a demonstrative implementation, the system may include the following layers: (1) Presentation: From this layer all input and data manipulation is performed. This layer consists of web, mobile and tablet clients that all use the Same API provided mainly by the file share business logic. (2) Business logic: Provides the business services for the client applications. The presentation layer will consume all its services from this layer. (3) Application services: A set of services that provide backend of the system. These services will mainly be consumed by the ROA service. (4) Data services: As set of services that collects relevant data into the system, mainly from third parties and the Internet. (5) DAL: Data ORM server that interacts with the database. Most of the data manipulation (inserts, deletes, update, and views) should be done in this layer. In some cases this layer will activate procedures from the database as well. (6) Storage: Represents database of the platform; there may be multiple database, for example, to server the production environment, and for Business Intelligence (BI) purposes. Reports may be held on the production data base server by using a reporting service module.

Some embodiments of the present invention may include a method, system and/or module to find, mark and analyze websites that are operated by authorized affiliates of the brand owner. Many organizations have a large number of affiliates (sometimes also defined as partners, business partners, resellers, distributors, or the like) that may be allowed to sell or offer the organization's products and/or services to the general public or to other merchants. In that regards such affiliate entities may be entitled for a certain usage of the brand—for example, the use of the brand in the content of their website, the use of the logo, and sometimes even the use of the brand in the domain name. Different organizations have different policies in regards to the use of their brand and trade marks by their affiliates.

When the brand monitoring and protection system performs its analysis, unless the organization has a list of the domain names of all the affiliates and provides it to the system in advance, the system may initially regard these websites (of affiliate entities) as potential risks to the brand. Since the number of affiliates may be large, the information about their domain names may not be easily retrieved by the organization, and many times the domain names they use may change, and this may create a problem for the organization to monitor the use by such affiliates. Furthermore, affiliates may be terminated but might continue to perform an unpermitted use of the brand, thereby creating even greater problem for the organization.

In order to resolve this problem that the Applicants have identified, the following solution may be provided by the system of the present invention. The organization may utilize the system to create and/or provide a verification package for each affiliate, which includes a “certificate”. The certificate may be an encoded piece of code that has to be incorporated in the homepage (or a different page) of the affiliate's website or on the webserver, based on the requirements provided by the system. Each encoded certificate is created for each affiliate, and each one has a code that is unique for that affiliate and/or for the specific website being operated by the affiliate (e.g., unique certificate per affiliate, and/or per website operated by affiliate, and/or per domain used by affiliate). In case the affiliate has more than one website then additional unique certificate(s) can be created for such additional website(s) of that affiliate.

When the system finds a website to be a suspected risk, it looks for the certificate in the code of the website. If the unique code is found, then the website is marked as an affiliated website. The user will then be able to monitor that website through the affiliates module. All affiliates' websites may be analyzed by the system in a similar way to the evaluations module, and allow the user to get an analysis for the relative contribution of each affiliate website to the brand.

The user (brand owner) may define restrictions for affiliates. For example—the user can define that an affiliate is not allowed to use the brand name in the domain name it operates. If an affiliate website is found to be violating a restriction, it will be marked under the “violating affiliate websites” section in the Affiliate module. The module includes a warning notification section similar to the Cease and Desist tool of the system, dedicated to send warnings and “cease and desist” notifications to violating affiliates.

In case the system finds the same code in more than one website, it means that the code was copied. The system will mark the websites with the same code as “suspected violating websites”. The user may define an automatic notification to the relevant affiliate to check and resolve the issue. If the affiliate reports back that one of the websites does not belong to the affiliate's organization, the user will be able to mark that website as a risk and automatically send a new code to the affiliate for use in approved website(s). If the affiliate reports back asking for an additional code for the second website which is owned by the affiliate's organization, the user may request to automatically send an additional code for that affiliate for the additional website.

The Affiliates module also includes an initial implementation section, to which the user can upload or enter a list of affiliates (including their email addresses). The user is able to automatically create and send a “certificate requirement notification” to multiple affiliates by email or regular mail. The unique certificates will be automatically created by the system for each affiliate, and may be attached to the notification. The user is able to edit the text of the notification.

In some embodiments, optionally, each unique certificate may have (or may be associated with) an expiration date (e.g., 365 days or 180 days from certificate issuance), which may be set in advance by the brand owner, and may be embedded in and/or encoded within the unique certificate. The Affiliates module which finds and analyses such certificates, may take into account the expiration date of each certificate. An expired certificate may be regarded as if the certificate does not exist; or, may be handled differently (e.g., by showing to the brand owner a list of expired certificates and allowing the brand owner to take further steps). In some embodiments, the system may handle differently, for example, a certificate that expired recently (e.g., a week ago, possibly due to forgetting to renew it) or a certificate that expired further in the past (e.g., two years ago, possibly by an entity that is no longer an active or authorized affiliate of the brand owner).

The present invention may be implemented by a suitable combination of hardware components and/or software modules; using a server or multiple servers; a computer or computerized device, a workstation, or the like.

The present invention may be implemented as a computerized system which may comprise, for example, a processor, a CPU, memory unit, storage unit, a database, input unit (keyboard, mouse, keypad, touch-screen, touchpad), output unit (screen, touch-screen), wired and/or wireless transceiver or modem or network interface card, power source, Operating System, drivers, one or more applications, or the like.

Some embodiments may be implemented by using hardware components; or by using a non “pure software” implementation; or by an implementation that is not “pure software” and is not “software per se”. Some embodiments may include hardware components (e.g., computers, servers, storage devices, memory devices, processors, or the like) for achieving or implementing the operations described herein. Some embodiments may affect the real-world, and/or may have an effect on the real world; as they may allow a brand owner to protect its brand from being abused, for example, by stopping or reducing sale or distribution of counterfeit merchandise or fake goods. Some embodiments, may provide technical solution to a technical problem, and/or may provide a technological solution to a technological problem; such as, how to efficiently and/or automatically detect, stop and/or reduce abuse of brand-names, online and/or offline.

Some of the features described above may be optional, and may not necessarily be included in all the embodiments of the present invention. Features may be combined or modified to achieve desired results.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may take the form of an entirely hardware embodiment, an entirely software embodiment, or an embodiment including both hardware and software elements. Some embodiments of the present invention may be implemented in software, firmware, resident software, microcode, an application which may be downloaded and/or installed by a user, an application which may run in a browser, a client-side application, a server-side application, a client-server application, or the like. Some embodiments of the present invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system or device. Some embodiments of the present invention may be implemented, for example, using a machine-readable medium or article which may store an instruction or a set of instructions that, if executed by a machine, cause the machine (e.g., a computer or an electronic device) to perform a method and/or operations described herein.

Some embodiments of the present invention may include or may utilize, for example, a processor, a central processing unit (CPU), a digital signal processor (DSP), a controller, an integrated circuit (IC), a memory unit, a storage unit, input units, output units, wired and/or wireless communication units, an operating system, and other suitable hardware components and/or software modules.

Some embodiments may be implemented as, or by utilizing, an application or “app” for a Smartphone or tablet or portable computing device, which may be downloaded and/or installed onto such electronic device from an “app store” or an online marketplace for applications.

In some implementations, the terms “website” and “domain” may be inter-changeable; such that, for example, operations that are described herein with regard to a domain, may be applied to a website: and/or vice versa, such that operations that are described herein with regard to a website, may be applied to a domain. In some implementations, the term “website” may comprise a web-page; and may optionally comprise a profile or a page of an entity (e.g., a person, a company, a legal entity) in a social media website or a social network.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method of protecting a brand name of a brand owner, the method comprising:
(a) crawling a global communication network to identify and collect data about web-sites that possibly abuse the brand name;
(b) for each web-site that possibly abuses the brand name, analyzing whether or not the web-site abuses the brand name by analyzing at least one of: (i) content of said web-site; and (ii) data about an owner of said web-site.

2. The computerized method of claim 1, comprising:
for each web-site that possibly abuses the brand name, generating an investment score indicating an estimated level of investment that was invested in development of said web-site.

3. The computerized method of claim 2, comprising:
for each web-site that possibly abuses the brand name, generating a damage score indicating a level of damage that said web-site is estimated to produce to said brand name.

4. The computerized method of claim 3, comprising:
for each domain that possibly abuses the web-site, generating a popularity score indicating a level of popularity of said web-site among users of the global communication network.

5. The computerized method of claim 4, comprising:
for each domain that possibly abuses the brand name, generating a relevance score indicating a level of relevance of said domain to said brand.

6. The computerized method of claim 5, comprising:
for each web-site that possibly abuses the brand name, generating an aggregated risk score based on, at least, one or more of: said investment score, said popularity score, said damage score, and said relevance score.

7. The computerized method of claim 1, comprising:
identifying a common pattern among multiple web-sites that are determined, by the computerized method, to be abusing the brand name.

8. The computerized method of claim 7, wherein identifying the common pattern among the multiple web-sites is performed based on at least one of:
identifying common domain ownership for said multiple web-sites;
identifying common domain registrar for said multiple web-sites;
identifying common DNS server for said multiple web-sites;
identifying common Internet Protocol (IP) address for said multiple web-sites;
identifying common content for said multiple web-sites;
identifying common web-site use type for said multiple domains;
identifying that multiple Internet Protocol (IP) addresses of said multiple web-sites belong to a same country;
identifying that said multiple web-sites have a same country code Top-Level Domain (ccTLD);
identifying that WHOIS records of said multiple web-sites share at least one same contact detail.

9. The computerized method of claim 7, comprising:
identifying a batch of multiple web-sites, that are owned by different entities and are determined by the computerized method to be abusing the brand name;
automatically generating drafts of cease-and-desist notifications directed to said entities;
upon approval of the brand owner, sending out said cease-and-desist notifications to said entities.

10. The computerized method of claim 1, comprising:
for a particular web-site that is determined by the computerized method to be abusing the brand name,
automatically analyzing at least (i) content of said web-site, and (ii) domain registration data of said web-site;
based on said analyzing, automatically presenting to the brand owner at least one option selected from: (a) to automatically send a cease-and-desist notification to an owner of said particular web-site, (b) to automatically start a negotiation process for purchasing said particular web-site, (c) to automatically send a take-down notice to a hosting service of said web-site.

11. The computerized method of claim 1, comprising:
generating a list of multiple web-sites that are determined by the computerized method to be abusing said brand name;
presenting to the brand owner said list of multiple web-sites.

12. The computerized method of claim 11, comprising:
sub-grouping web-sites in said list, based on Top-Level Domain (TLD) of said web-sites.

13. The computerized method of claim 11, comprising:
sub-grouping web-sites in said list, based on country code Top-Level Domain (ccTLD) of said web-sites.

14. The computerized method of claim 11, comprising:
sub-grouping domains in said list, based on a level of aggregated risk to the brand name.

15. The computerized method of claim 1, further comprising:
based on keywords entered by the brand owner, analyzing crawled data and identifying web-sites that abuse the brand name; wherein the keywords entered by the brand owner are used for generating a relevance score for each one of said web-sites.

16. The computerized method of claim 1, further comprising:
based on names of one or more competitors, that are entered by the brand owner, analyzing crawled data and identifying web-sites that abuse the brand name.

17. The computerized method of claim 1, further comprising:
based on a use type of a possibly-abusing web-site, analyzing crawled data and determining whether or not the possibly-abusing web-site abuses the brand name.

18. The computerized method of claim 1, further comprising:
determining that a possibly-abusing web-site is used for domain parking;
based on said determining, generating a determination whether or not the possibly-abusing domain abuses the brand name.

19. The computerized method of claim 1, further comprising:
determining that a possibly-abusing web-site is used for pay-per-click advertisements;
based on said determining, generating a determination that the possibly-abusing web-site abuses the brand name.

20. The computerized method of claim 1, further comprising:
determining that a possibly-abusing web-site is used for redirecting Internet traffic to a web-site associated with a competitor of the brand owner;
based on said determining, generating a determination that the possibly-abusing web-site abuses the brand name.

21. The computerized method of claim 1, further comprising:
determining that a possibly-abusing web-site is used for electronic commerce of counterfeit merchandise;
based on said determining, generating a determination that the possibly-abusing web-site abuses the brand name.

22. The computerized method of claim 1, further comprising:
generating a determination that a possibly-abusing web-site abuses the brand name, based on an analysis that takes into account at least one of: (i) a current content of said possibly-abusing web-site; (ii) a past content of said possibly-abusing web-site, which is different from said current content.

23. The computerized method of claim 1, further comprising:
generating a determination that a possibly-abusing web-site abuses the brand name, based on an analysis that takes into account at least one of: (i) a current type of use of said possibly-abusing web-site; (ii) a past type of use of said possibly-abusing web-site, which is different from said current type of use.

24. The computerized method of claim 1, further comprising:
determining that a possibly-abusing web-site appears in a pre-defined white-list of web-sites that are authorized by the brand owner to mention the brand name;
based on said determining, generating a determination that the possibly-abusing web-site does not abuse the brand name.

25. The computerized method of claim 1, further comprising:
determining that a possibly-abusing web-site is owned by an authorized affiliate of the brand owner;
based on said determining, and based on other estimated risk factors associated with said web-site, generating a determination whether or not the possibly-abusing web-site is abusing the brand name.

26. The computerized method of claim 1, further comprising:
determining that a possibly-abusing web-site is owned by an authorized affiliate of the brand owner, based on a unique code portion that is found embedded within a source code served from said web-site, wherein the unique code portion is unique per authorized affiliate of the brand owner.

27. The computerized method of claim 1, further comprising:
determining that a possibly-abusing web-site is owned by an authorized affiliate of the brand owner, based on a unique code portion that is found embedded within a source code served from said web-site, wherein the unique code portion is unique per web-site of authorized affiliate of the brand owner.

28. The computerized method of claim 3, comprising:
determining that a web-site that abuses the brand name, performs at least one of: (a) sells counterfeit merchandise; (b) directs users to a web-site of a competitor of the brand owner;
in response to said determining, increasing the damage score for said web-site.

29. The computerized method of claim 1, further comprising:
analyzing at least one of: (i) content of a list of domains that are owned by the brand owner, (ii) Internet traffic to said list of domains that are owned by the brand owner;
based on the analyzing, identifying a particular domain on said list, that is under-monetized;
generating a notification to the brand owner to perform self-monetization of said particular domain.

30. The computerized method of claim 1, further comprising:
collecting domain registration data for a batch of domains that are owned by the brand owner;
analyzing the domain registration data for said batch of domains, to determine at least one domain having registration details that are incorrect;
generating a notification to the brand owner, indicating that said at least one domain has registration details that require correction.

31. The computerized method of claim 30, further comprising:
automatically correcting domain registration data, for the at least one domain that has incorrect domain registration details, based on a default profile of registration data pre-defined by said brand owner.

32. The computerized method of claim 1, further comprising:
collecting domain registration data for a batch of domains that are owned by the brand owner;
analyzing the domain registration data for said batch of domains, to determine upcoming expiration dates of said domains;
based on the analyzing, generating notifications to the brand owner with regard to domain renewals, grouped into (i) a first group of urgent domain renewals, and (ii) a second group of non-urgent domain renewals.

33. The computerized method of claim 1, further comprising:
performing a domain availability analysis that takes into account at least one of: (i) the brand name: (ii) one or more user-provided keywords that are related to the brand name; (iii) one or more system-generated keywords that are related to the brand name; (iv) one or more countries-of-interest; (v) one or more global Top-Level Domains (gTLDs) of interest;
based on the domain availability analysis, performing a domain opportunity analysis to determine a particular domain name that is (A) available for registration, and (B) is relevant to the brand name;
generating a notification that proposes to the brand owner to register said particular domain.

34. The computerized method of claim 33, further comprising:
based on the domain opportunity analysis, performing generating a list of multiple domains that are (a) available for registration, and (b) are relevant to the brand name;
ranking said list of multiple domains by using a prioritizing algorithm that takes into account at least one of: (A) system-generated keywords; (B) user-provided keywords; (C) countries-of-interest; (D) global TLD of interest; (E) semantic analysis of the brand name: (F) common typos; (G) common linguistic mutations.

35. The computerized method of claim 1, further comprising:
generating a mutation of said brand name by introducing a typographical error to said brand name;
generating a candidate domain by adding a Top Level Domain (TLD) suffix to the mutation of the brand name;
based on domain registrar data, checking whether the candidate domain is registered to an entity other than the brand owner;
if the candidate domain is registered to an entity other than the brand owner, then, (i) analyzing a use of a web-site served from said candidate domain, and (ii) based on the analyzing, determining whether the candidate domain is abusing the brand name.

36. The computerized method of claim 1, further comprising:
generating a mutation of one or more keywords that are related to said brand name, by introducing a typographical error to said one or more keywords;
generating a candidate domain by adding a Top Level Domain (TLD) suffix to the mutation, wherein the candidate domain comprises said brand name and said mutation of one or more keywords;
based on domain registrar data, checking whether the candidate domain is registered to an entity other than the brand owner;
if the candidate domain is registered to an entity other than the brand owner, then, (i) analyzing a use of a web-site served from said candidate domain, and (ii) based on the analyzing, determining whether the candidate domain is abusing the brand name.

37. The computerized method of claim 1, further comprising:
determining one or more keywords, that are related to the brand name;
performing a search engine query that comprises said one or more keywords;
selecting a web-site that appears in search results of said search engine query;
analyzing at least one of: (i) content of said web-site, (ii) Internet traffic to said web-site, to determine whether or not said web-site abuses the brand name.

38. The computerized method of claim 1, further comprising:
determining one or more keywords, that are related to the brand name;
performing a search engine query that comprises said one or more keywords;
selecting a web-site that appears in search results of said search engine query;
obtaining through a domain registry data about an owner of said web-site;
if said web-site is owned by an entity other than the brand owner, then, analyzing content of said web-site to determine whether or not said web-site abuses the brand name.

39. The computerized method of claim 1, further comprising:
generating a cost effectiveness score for Search Engine Optimization (SEO) operations performed for a web-site of the brand owner, by:
(a) at a first time point, determining a first ranking of said web-site in search results of a particular search engine:
(b) at a second time point, determining a second ranking of said web-site in search results of a particular search engine;
(c) obtaining a user indication of monetary investment in SEO performed between the first time point and the second time point;
(d) generating the cost effectiveness score by taking into account, at least, the change between the first ranking and the second ranking, and said monetary investment in SEO.

40. The computerized method of claim 1, further comprising:
generating a cost effectiveness score for digital marketing operations performed for a web-site of the brand owner, by:
(a) at a first time point, determining a first ranking of said web-site in search results of a particular search engine;
(b) at a second time point, determining a second ranking of said web-site in search results of a particular search engine;
(c) obtaining a user indication of monetary investment in digital marketing performed between the first time point and the second time point;
(d) generating the cost effectiveness score by taking into account, at least, a change between the first ranking and the second ranking, and said monetary investment in digital marketing.

41. The computerized method of claim 1, further comprising:
generating a cost effectiveness score for Search Engine Optimization (SEO) operations performed for a web-site of the brand owner, by:
(a) at a first time point, determining a first ranking of said web-site in search results of a particular search engine;
(b) at a second time point, determining a second ranking of said web-site in search results of a particular search engine;
(c) generating the cost effectiveness score by taking into account, at least, change between (i) the first ranking at the first time-point, and (ii) the second ranking at the second time point.

42. The computerized method of claim 1, further comprising:
generating a cost effectiveness score for digital marketing operations performed for a web-site of the brand owner, by:
(a) at a first time point, determining a first ranking of said web-site in search results of a particular search engine;
(b) at a second time point, determining a second ranking of said web-site in search results of a particular search engine;
(c) generating the cost effectiveness score by taking into account, at least, change between (i) the first ranking at the first time-point, and (ii) the second ranking at the second time point.

43. The computerized method of claim 1, wherein the brand name comprises a name of a person.

44. The computerized method of claim 1, wherein the analyzing further takes into account at least one of: keywords used in the content of said web-site, Internet traffic data for said web-site, Search Engine Optimization (SEO) data of said web-site, structure of said web-site, programming technologies used by said web-site.

45. The computerized method of claim 2, wherein generating the investment score is based on an analysis that takes into account at least one of:
level of sophistication of one or more programming technologies used by said web-site;
whether one or more programming technologies used by said web-site are recent or outdated;
an amount of content contained in said web-site;
a number of web-pages contained in said web-site;
whether or not said web-site is compliant with World Wide Web Consortium (W3C) requirements;
whether or not said web-site is compliant with Search Engine Optimization (SEO) standards.

46. The computerized method of claim 1, further comprising:
identifying a common pattern for multiple cross-brand abusing web-sites.

47. The computerized method of claim 46, comprising:
detecting a first web-site which abuses a first brand name of a first brand owner;
detecting a second web-site which abuses a second, different, brand name, of a second, different, owner;
detecting one or more common characteristics that are common the first and second web-sites.

48. The computerized method of claim 47, comprising:
sending a notification about detection of the multiple cross-brand abusing web-sites, to at least one of the first brand owner and the second brand owner.

49. The computerized method of claim 47, comprising:
sending a notification about detection of the multiple cross-brand abusing web-sites, to at least one of the first brand owner and the second brand owner;
enabling a cooperative action to be taken by the first and second brand owner.

50. The computerized method of claim 1, comprising:
determining that a certain web-site is abusing the brand name;
searching in a secondary marketplace for domains and/or web-sites, whether said certain web-site is offered for sale;
if said certain web-site is offered for sale, through said secondary marketplace, then enabling to the brand owner to purchase said certain web-site through an automated system that interfaces with said secondary marketplace.

51. The computerized method of claim 1, comprising:
determining that a batch of multiple websites are abusing the brand name;
searching in a secondary marketplace for domains and/or websites, which ones of said multiple websites are offered for sale;
generating a list of said multiple websites that are abusing the brand name, and indicating on said list one or more of the websites that are offered for sale on the secondary marketplace.

52. The computerized method of claim 1, comprising:
scanning an entire registry of a Top-Level Domain (TLD) for websites that abuse any one of a group of brand names;
generating a risk score for each one of said websites;
based on the risk score, generating a ranked list of said websites.

53. The computerized method of claim 1, comprising:
scanning an entire registry of a Top-Level Domain (TLD) for websites that are non-compliant with one or more rules that apply to said TLD registry;
generating a non-compliance score for each one of said websites;
based on the non-compliance score, generating a ranked list of said websites.

54. The computerized method of claim 1, comprising:
determining that a certain website is possibly abusing the brand name;
capturing and storing a screenshot of said website, together with a time-and-date stamp.
